(19) United States
(12) Patent Application Publication
(10) Pub. No.: US 2007/0234602 A1
(43) Pub. Date: Oct. 11, 2007

(54) Art sheets storage, display and retrieval systems

(76) Inventor: Cherng Chang, Rowland Heights, CA (US)

Correspondence Address: CHANG, CHERNG, PO Box 8574, Rowland Heights, CA, 91748, US

(21) Appl. No.: 11/809,976

(22) Filed: Jun. 4, 2007

Related U.S. Application Data
(63) Continuation-in-part of application No. 11/217,044, filed on Sep. 1, 2005.
(60) Provisional application No. 60/811,356, filed on Jun. 7, 2006.

(51) Int. Cl. B42F 17/00

(52) U.S. Cl. 40/373; 700/1

(57) ABSTRACT

A novel system for art sheets storage, display and retrieval in a retail store. It includes a motor-powered, computer-controlled display unit for displaying art sheets for store shoppers on request. Located above the display unit is a small pictures panel displaying duplicated pictures, but at reduced sizes, of all art sheets stored in a storage case of the system. A shopper can walk down the store aisle to view these small pictures. Once a small picture of interest is spotted, the shopper can press a button in a keypad to request a “Single Picture Show” in which the requested art sheet is displayed by the display unit. A “Group Picture Show” can also be requested to display all or a group of art sheets, one at a time, each being displayed for a pre-determined duration. A computer program is disclosed for operating this display unit. A novel motor-powered moving loop belt display stand is also disclosed. Art sheets to be displayed are mounted spaced apart on the belt, at right angle with respect to the belt surface. Small picture panels and art sheet slips are also provided to complement this display stand. A novel business method will enable a customer to pick up an art frame slip and several art sheet slips for the actual products to be purchased. After checkout, a customer-selected assembled frame will be retrieved, assembled, and picked up at the customer service department.

### CLAIM PRIORITY

U.S. Provisional Application No. 60/811,356, filed Jun. 7, 2006

### BACKGROUND OF THE INVENTION

This invention relates in general to art sheets storage, display, and retrieval, but also relates to the storage, display and retrieval of other art supplies including art frames and mat boards.

A recent survey indicates that art sheets in US, either framed or unframed, were sold through art galleries (30%), department stores (27%), discount stores (25%), custom frame shops (24%), home products stores (20%), museum stores (13%), furniture stores (12%) and others (31%, total more than 100%).

Art galleries/custom framing stores have long dominated the US wall sheet art market. In present day art galleries, most art sheets are each stored in a large soft vinyl transparent envelope. This envelope must be made large and thus heavy so all art sheets of various size will each fit in one such envelope. It is not an easy job to search through art sheets in stock because the very action of flipping can be tiring by going through just 20 or 30 such envelopes.

In many stores, large poster arts are also individually displayed in a vinyl envelope vertically hinged so customers can turn each envelope to see these art posters on display. Once an art poster is found of interest, the customer can go by the number and find this same poster individually rolled in a tube for pick up. Although the envelope turning may be less tiring than envelope flipping, very few stores keep more than 50-100 different art poster rolls, the upper limit of customer tolerance.

Some discount stores in recent years began to stock median size art sheets (16″×20″, 40 cm×50 cm, or 11″×14″, 28 cm×36 cm). Each such art sheet is backed by a cardboard and wrapped in a transparent sheet. A cardboard box can hold many of such art sheets. Although such art sheets are easier to flip because of its smaller sizes, still not many customers are willing to flip more than 50-100 sheets before their patience run out.

There is one more problem with the cardboard box art sheets storage and display. Usually two or more identical art sheets are stacked together. This means that the customer may have to flip two or more identical art sheets before reaching to the next different art sheet. Once an art sheet is sold out, it is rarely restocked. Later customers will simply have less and less choice of art sheets to work with.

The basic problem of going through large number of art sheets by flipping or turning through each art sheet or envelope without knowing beforehand what art sheet it will be encountered is a very inefficient method. Since most art sheets encountered are probably not of interest to the searcher which will result in large wasted flipping effort. Because of the tiring factor above described, most customers simply give up the search after just a few flipping actions.

In comparison, search through Internet or publishers' catalogs for interested art sheets is a more efficient search method. Many art sheets in small image print or screen display are shown in one page simultaneously. In the case of Internet, a click of one small image of interest usually redisplays the same image in full scale. But one main problem with these search methods is that one can not view the actual art sheet before buying it.

The same survey mentioned above also reveals that top 25% of buyers consider them self as sophisticated art buyers. They search the art galleries and art museums for arts either by artists's names or categories. Once an art sheet is purchased, it will be custom framed at high cost.

The remaining 75% of art sheet buyers typically shop at large chain home furnishing stores, department stores, specialty stores, and mass channels. They usually prefer purchasing a pre-framed art in order to avoid extra effort and high cost in custom framing. They mostly purchase arts through so called “chance encountering”, i.e., one happen to encounter an art he likes. But in reality, it may be difficult for a pre-framed art shopper to find one he truly likes in view of limited selection available to him. The reason for this limited selection is two folds. Compared with an art sheet alone, the art sheet with a frame is much bulkier which limits the number of pre-framed arts that can be carried in a store. The second reason is that if this store is not dedicated to the sale of pre-framed arts, the available store space set aside for displaying these arts would also be very limited. It is not a easy job to hop all local stores to find one desired pre-framed art. Out of frustration, many customers often settled on second best selection but regret on this decision six months later after the purchase.

### SUMMARY OF THE INVENTION

Several novel improvements in the area of art sheets storage, display, and retrieval in a retail store are disclosed. In a typical big box retail store with high ceiling a tall shelf stand with several shelves can be employed for storage of art sheets. A display box placed on the floor in front of the shelf stand will be used for storing art sheets to be viewed and retrieved by shoppers.

The frontal space of the shelf stand above the display box not accessible to the shoppers can be covered by a front panel. It will be used for displaying duplicated pictures, but at reduced sizes, of all the art sheets stored in the display box. Each such small picture is accompanied by the exact location (folder number) of the corresponding art sheet in the display box. A shopper can walk down the aisle to view these small pictures displayed on the front panel. Once a small picture of interest is spotted, the shopper can quickly find the actual art sheet by its folder number in the display box. No flipping through all piles of art sheets is required.

To further improve the art sheet display and retrieval it is proposed that all art sheets accessible to shoppers in a retail store be placed in one or more multiple drawers stands. A typical 4-ft or slightly higher drawers stand can have up to forty (40) drawers. Each drawer can hold up to fifty (50) identical art sheets unwrapped and without cardboard support. Once the art sheet of interest is identified by viewing the small picture panel, the shopper can then pull open the corresponding drawer to examine the art sheet itself. Once the drawer is open, the art sheet to be examined is laid flat fully exposed away from the shelf stand. The shopper can leisurely feel and touch the art sheet. If interested, the shopper can easily take one sheet out for purchase.

It is also desirable that this multiple drawers stand be motor-powered and electrically controlled and operated. Any drawer can be opened (Single Picture Show) by simply pushing a open/close switch for that drawer. This drawers stand, when coupled with the small picture panel display, will open up a new and efficient way for finding and obtaining an art sheet of interest to a shopper with minimum labor requirement.

It is also possible to further improve this motor-powered multiple drawer stand by adding a microcontroller with a computer program imbedded therein. A keypad with several buttons can also be made available to a shopper to initiate a Single Picture Show as well as three Multiple Picture Shows. An All Picture Show, Group Picture Show, or Special Group Picture Show can be requested by the shopper by pressing appropriate button(s) on the keypad to open all drawers or a group of drawers, one drawer at a time, each being opened for a pre-determined duration. A Hold button can be pushed to hold the currently opened drawer in the open position to give the shopper more time to examine the displayed art sheet and to take one out for purchase. The push of a Resume button will resume the requested Multiple Picture Show.

A motor-powered and computer-controlled art sheets display box can also be similarly constructed for performing both Single Picture Show and Multiple Picture Shows. It can be coupled with a small picture panel and a case or drawer stand for storing art sheets either in flat or rolled forms and for art sheet retrieval.

A third art sheets storage, display, and retrieval system, again without drawer and mainly for rolled poster arts, is also disclosed. In this system, all displayed art sheets are suspended on a loop belt powered by a motor to rotate continuously in front of a shopper. Each displayed art sheet is accompanied by a number. Once an art sheet is found by the shopper of interest, he can pick up one roll marked by the number for purchase. No computer control is needed for this system.

A novel business method will enable a customer to pick up an art frame slip and several art sheet slips for the actual products for checkout. At the checkout counter the list of products to be retrieved is electronically transmitted to the store's customer service department which maintains the storage of such products. After checkout, a customer-selected ensemble will be retrieved, assembled, and picked up at the customer service department.

### BRIEF DESCRIPTION OF THE DRAWINGS

FIG. 15 shows one arrangement for storing the art sheets and preview of each stored art sheet.

FIG. 16 shows the same arrangement as shown in FIG. 15 but with the use of a panel which allows more small pictures to be previewed.

FIG. 17 shows a panel hinged on a shelf station for displaying corner samples of art frames available in the art store.

FIG. 18 shows the same panel of FIG. 17 for displaying corner samples of mats available in the art store.

FIG. 24 is a perspective view of a multiple drawer stand, a shelf stand, and a small picture panel.

FIG. 25 is a side view, showing an art sheet drawer and its drawer operator.

FIG. 26 is a perspective view, showing a clock-like timing system for controlling the operation of the ten drawers shown in FIG. 24.

FIG. 27 is a schematic electronic circuit diagram for a computer based system for performing the picture show.

FIG. 28 is a perspective view, showing a prototype drawer stand and a small picture panel placed above said stand.

FIG. 29 is a schematic electronic circuit diagram for a computer based system for operating the prototype drawer stand shown in FIG. 28.

FIGS. 30A to 30F are flow charts for describing the computer program listed in Appendix I for operating the prototype drawer shown in FIG. 28.

FIG. 31 is a perspective view, showing the largely same prototype drawer stand of FIG. 28, renamed as a display box, turned 90 degree sideway, placed on top of a case storing rolls of art sheets. A portion of the side wall of the display box is broken away to reveal the inside details.

FIG. 32 shows the display box of FIG. 31, again turned 90 degree, placed on top of a case storing rolls of art sheets.

FIG. 33 shows a display box capable of displaying eight art sheets, placed on top of a case storing rolls of art sheets.

FIG. 34 shows the display box of FIG. 33, placed on top of a case storing stacks of flat art sheets.

FIG. 35 shows the display box of FIG. 33, placed on top of a drawer stand storing stacks of flat art sheets.

FIG. 36 is an elevational view, showing a rotating art sheet display stand, a small picture panel and a case storing rolls of art sheets.

FIG. 41 shows a panel hinged on a shelf station for displaying corner samples of art frames available in the art store, and a display box holding sample of each such art frame and holding pockets containing art frame slips of these art frames.

FIG. 42 is an elevational view, showing a small picture panel, an art sheet display box, and a panel holding pockets containing art sheet slips of art sheets to be displayed in this display box.

FIG. 43 is an elevational view, showing the details of an art frame slip and an art sheet slip.

FIG. 47 is a perspective view, showing three art sheet display stations along a store's aisle.

FIG. 48 is an elevational view, showing the rotating art sheet display stand and the small picture panel of FIG. 36 and a case storing art sheet slips of all art sheets displayed in the display stand.

FIG. 49 is an elevational view of a purchase receipt.

FIG. 50 shows a hypothetic storage area including four storage locations.

FIG. 51 is an elevational view, showing the purchase receipt of FIG. 49 with operator's check marks and initial.

FIG. 52 is an elevational view, showing the purchase receipt of FIG. 49 with customer's signature.

REFERENCE NUMERALS IN DRAWINGS

| | | | | |
|---|---|---|---|---|
| FIGS. | 400 | shelf stand (station) | 402 | shelf |
| 15-18 | 404 | shelf | 406 | shelf |
| | 410 | outer box | | |
| | 412 | outer box | 414 | outer box |
| | 416 | inner boxes | 418 | art sheets |
| | 420 | labels | 422 | display box |
| | 424 | divider cards | 426 | tabs |
| | 428 | thumb tags | 430 | wooden studs |
| | 432 | panel | 434 | screws |
| | 435 | outer box | 436 | outer box |
| | 437 | outer box | 438 | display box |
| | 440 | panel | 442 | hinge |
| | 443 | shelf station | | |
| | 444 | hinge stem | 446 | hinge seat |
| | 448 | screws | 450 | screws |
| | 452 | display box | 454 | divider cards |
| | 456 | tabs | 458 | thumb tags |
| | 460 | art frames | 462 | art frame box |
| | 464 | art frame box | 466 | art frame box |
| | 470 | shelf station | 472 | display box |
| | 474 | divider cards | 476 | tabs |
| | 478 | thumb tags | 480 | panel |
| | 482 | mat box | 484 | mat box |
| | 486 | mat box | | |
| | 600 | multiple drawer stand | 602 | shelf stand |
| | 604 | drawers | 606 | art sheets |
| | 608 | removable shelves | 609 | shelf stand frame |
| | 610 | art sheet pack | 612 | front panel |
| | 614 | hinges | 616 | small pictures |
| | 618 | U-shaped guard | 620 | forward/reverse select |
| | | | | switch |
| | 752 | key pad | | |
| | 640 | drawer operator | 642 | reversible motor |
| | 644 | shaft | 646 | screw rod |
| | 648 | sleeve coupling | 650 | cup |
| | 652 | nut member | 654 | dash line drawer |
| | 700 | machine | 702 | clock |
| | 704 | second arm | 706 | rectangular plate |
| | 708 | forward/reverse select | 710 | ring member |
| | | switch | | |
| | 712 | ring plate | 714 | ring plate |
| | 716 | vertical plates | 718 | stud |
| | 720 | cylinder | 722 | top cover |
| | 724 | tension spring | 726 | iron rod |
| | 727 | electromagnetic coil | 728 | wire |
| | 730 | timer | 732 | iron disk |
| | 734 | dash line | | |
| | 750 | microcontroller | 752 | key pad |
| | 754 | reversible motor for | 756 | AC wire |
| | | drawer 3 | | |
| | 758 | AC wire | 760 | triac |
| | 762 | triac | 764 | capacitor |
| | 766 | reversible motor for | 768 | triac |
| | | drawer 4 | | |
| | 770 | triac | | |
| FIGS. | 800 | prototype drawer stand | 802 | small picture panel |
| 28-32 | | or display box | | |
| | 804 | open slot | 806 | open slot |
| | 808 | open slot | 810 | open slot |
| | 812 | stepper motor 1 (M1) | 814 | stepper motor 2 (M2) |
| | 816 | stepper motor 3 (M3) | 818 | stepper motor 4 (M4) |
| | 820 | back plate | 822 | shaft of motor 4 |
| | 824 | threaded rod | 826 | coupling |
| | 828 | horizontal/vertical bar | | |
| | | with a threaded hole | | |
| | 830 | vertical/horizontal | 832 | drawer 1 |
| | | bar | | |
| | 834 | drawer 2 | 836 | drawer 3 |
| | 838 | drawer 4 | | |
| | 840 | microcontroller | 842 | keypad |
| | 844 | TIP 120 transistors | | |
| | 850 | plate | 852 | an art sheet on display |
| | 854 | small pictures | 856 | sidewall of the display |
| | | | | box |
| | 860 | case | 862 | art sheet tubes |
| | 864 | compartments | 870 | horizontal beam |
| | 871 | case | 872 | compartments |
| | 874 | art sheet tubes | | |
| FIGS. | 900 | display box | 902 | art sheets |
| 33-35 | 904 | small picture panel | 906 | hinges |
| | 908 | small pictures | 910 | case |
| | 912 | vertical compartments | 914 | art sheet tubes |
| | 920 | case | 922 | horizontal compartments |
| | 924 | art sheets | 926 | recess |
| | 930 | drawer stand | 932 | drawers |
| | 934 | handles | | |
| | 950 | art sheet display | 952 | small picture panels |
| | | stand | | |
| | 954 | cases | 956 | drum |
| | 958 | drum | 960 | belt |
| | 962 | motor | 964 | motor shaft |
| | 966 | pulley | 968 | drum shaft |
| | 970 | pulley | 972 | belt |
| | 974 | boards | 976 | angle plates |
| | 978 | art sheets | 980 | vertical compartments |
| | 982 | art sheet tubes | 984 | small pictures |
| | 988 | forward/stop/backward | | |
| | | switch | | |
| | 990 | four on/off switches | | |
| | 402 | shelf | | |
| | 404 | shelf | 406 | shelf |
| | 440 | panel | 442 | hinge |
| | 443 | shelf station | | |
| | 444 | hinge stem | 446 | hinge seat |
| | 448 | screws | 450 | screws |
| | 452 | display box | 454 | divider cards |
| | 456 | tabs | 458 | thumb tags |
| | 460 | art frames | 462 | art frame box |
| | 464 | art frame box | 466 | art frame box |
| | 4202 | pockets | 4204 | art frame slips |
| | 900 | display box | 902 | art sheets |
| | 904 | small picture panel | 906 | hinges |
| | 908 | small pictures | 4206 | panel |
| | 4208 | pockets | 4210 | art sheet slips |
| | 4204 | art frame slip | 4210 | art sheet slip |
| | 4242 | art display box | 4244 | small picture panel |
| | 4246 | key pad | 4248 | key pad stand |
| | 4250 | art sheet slip box | 4251 | art sheet slips |
| | 4252 | art sheet slip box | 4254 | displayed art sheet |
| | | stand | | |
| | 4255 | displayed art sheet | | |
| | 950 | art sheet display | 952 | small picture panels |
| | | stand | | |
| | 956 | drum | | |
| | 958 | drum | 960 | belt |
| | 962 | motor | 964 | motor shaft |
| | 966 | pulley | 968 | drum shaft |
| | 970 | pulley | 972 | belt |
| | 974 | boards | 976 | angle plates |
| | 978 | art sheets | 984 | small pictures |
| | 988 | forward/stop/backward | 990 | four on/off switches |
| | | switch | | |
| | 4260 | art sheet slip case | 4262 | storage compartment |
| | 4264 | art sheet slips | | |
| FIGS. | 4330 | purchase receipt | 4332 | purchase receipt |
| 49-52 | 4334 | purchase receipt | 4340 | storage area |

### DETAILED DESCRIPTION

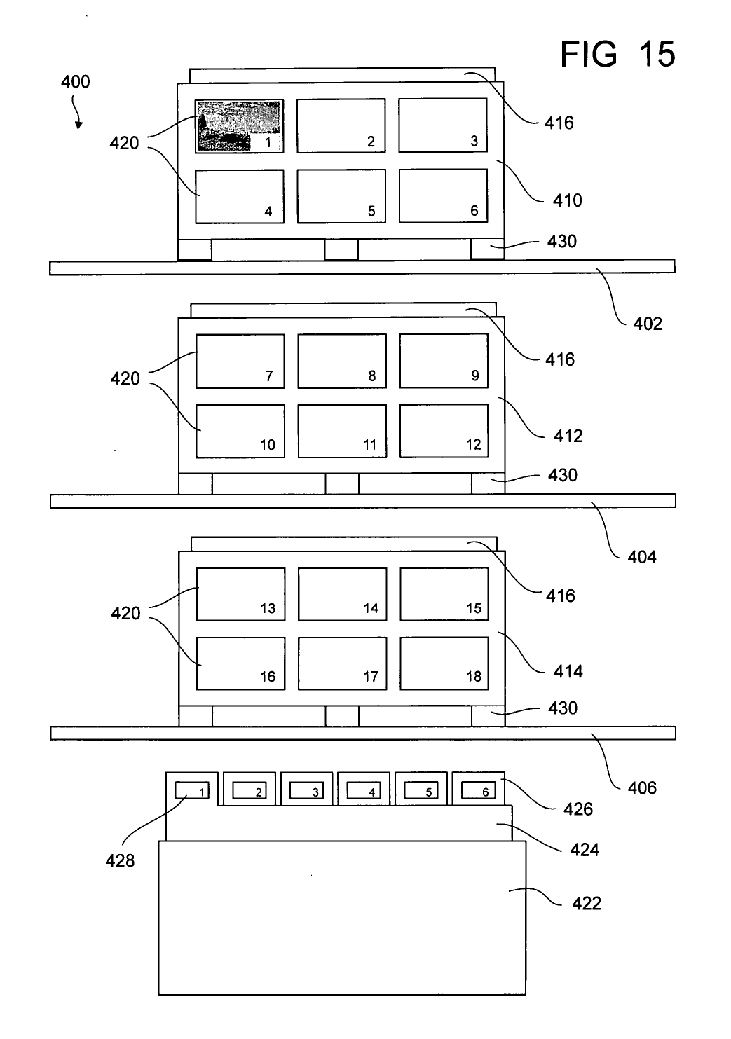

FIGS. 15-18

FIG. 15 shows one improved art sheets storage, display, and retrieval system in a retail store. For customers buying art sheets through chance encountering, this system will enable the customers to quickly spot and obtain the art sheets they like. A shelf stand 400 having three shelves 402, 404, and 406 is shown in this figure. Placed on the shelves 402, 404, 406 are three outer boxes 410, 412, and 414, respectively. Each of these outer boxes can hold six inner boxes 416. Each inner box will initially hold twenty (20) sheets of identical art sheets 418. Each art sheet is individually shrink wrapped along with a cardboard for reinforcement. In total there are eighteen (18) different art sheet boxes each having twenty (20) sheets stored. Since the outer boxes 410, 412, and 414 are placed on higher shelves and not accessible to store customers, all art sheets stored in these outer boxes are termed “un-accessible art sheets”.

There are six labels or small pictures 420 shown attached to the front side of the outer box 410. Each label 420 is printed with a duplicated picture of one art sheet stored in one inner box 416 but reduced in size. Beside the reduced size picture the art sheet number of this art sheet is also indicated on one label 420. Six labels are also similarly shown on the front sides of the outer boxes 412 and 414. In total there are eighteen (18) labels shown with eighteen reduced size pictures and art sheet numbers from 1 to 18 indicating the eighteen art sheets stored inside the eighteen inner boxes 416.

As seen in FIG. 15, placed on the floor and positioned in front of the shelf stand 400 is a display box 422 which is accessible to the customer. This will facilitate the loading and removal of art sheets without interference from the shelf stand and its shelves 402, 404, and 408. It is also possible to place the display box 422 on a flat bed with rollers which can be rolled in and out.

Instead of placing the display box 422 in front of the shelf stand 400, the display box can also be placed directly underneath the shelf 406 also as shown in FIG. 15. This will avoid taking up the precious store aisle space by the display box 422. Due to drawing sheet size limitation not much clearance space is provided between the display box 422 and the shelf 406. This clearance space should be much larger than what is shown in the drawing in order to facilitate flipping of the art sheets in the display box 422 by store shoppers.

There are eighteen divider cards 424 inserted in this display box 422. Each divider card 424 has a tab 426 on its top edge. These tabs are staggered so up to six tabs can be visible by a person standing in front of the display box 422. The other twelve tabs are each visible once some divider cards are flipped back out of the way. A small thumb tag 428 is applied to each of the eighteen tab 426 of the divider cards 424. Each thumb tag 428 is printed with a art sheet number of the stored art sheets.

As seen in the figure each of the outer boxes 410, 412 and 414 can be attached at its bottom with three wooden studs 430. The gaps between two adjacent studs 430 can allow a fork lift machine to engage with each outer box and move it off the shelf and lower it to a lower level accessible to an operator. In the beginning each inner box will be opened. Four identical art sheets will be removed from each inner box and placed behind the divider card with the thumb tag 428 marked by the art sheet number of these art sheets. So there will be a total of seventy two (72, 4×18) art sheets initially placed in the display box 422 accessible to a shopper. At a later time when all four art sheets of any one art sheet number are sold out the operator will repeat the above operation to take four more art sheets from the inner box and place them behind the divider card 424. Once the un-accessible art sheets are removed from any outer boxes 410, 412 and 414 and placed in the display box 422 which is accessible to the store customers, these un-accessible art sheets will now become accessible art sheets.

Customer buying art sheets through chance encountering will walk down each aisle and view all displayed labels 420. When he sees one label 420 showing an interesting picture he will locate the divider card 424 carrying the same art sheet number. He then pulls back this divider card and the sheet behind this divider card will be the art sheet he is interested. This is the easiest way to locate and retrieve the art sheet of interest without flipping all thousands of art sheets in stock in the art store.

In the above illustration each art sheets in stock for sale is represented by a small picture 420. This will allow the shopper to spot one small picture of interest and quickly locate the corresponding art sheet for further evaluation and purchase. For this illustration to be useful the size of small picture must be large enough for the shopper to see clearly at a distance. The size of the small picture must be at least one hundredth ( 1/100), preferably at least one twentieth ( 1/20), of that of the corresponding art sheet. Considerable amount of frontal space will be needed to display all such small pictures.

In FIG. 15, the three shelves 402, 404, and 406 located above the display box 422 will normally be used to store the additional art sheets not needed in the current sale. These three shelves will provide an ideal frontal space for displaying the eighteen small pictures. The small pictures are shown to be attached to the outer boxes 410, 412 and 414. But many other ways of displaying these small pictures in this frontal space are also possible.

It is important to emphasize that each small picture is a copy of the art sheet, but of reduced size. Many art sheets are copy right protected. A retail store is in general not allowed to make a copy of the art sheet of reduced size without the permission from the art sheet author. Special arrangement must be made to authorize a retail store to make copies of many different art sheets from different authors stored in the store.

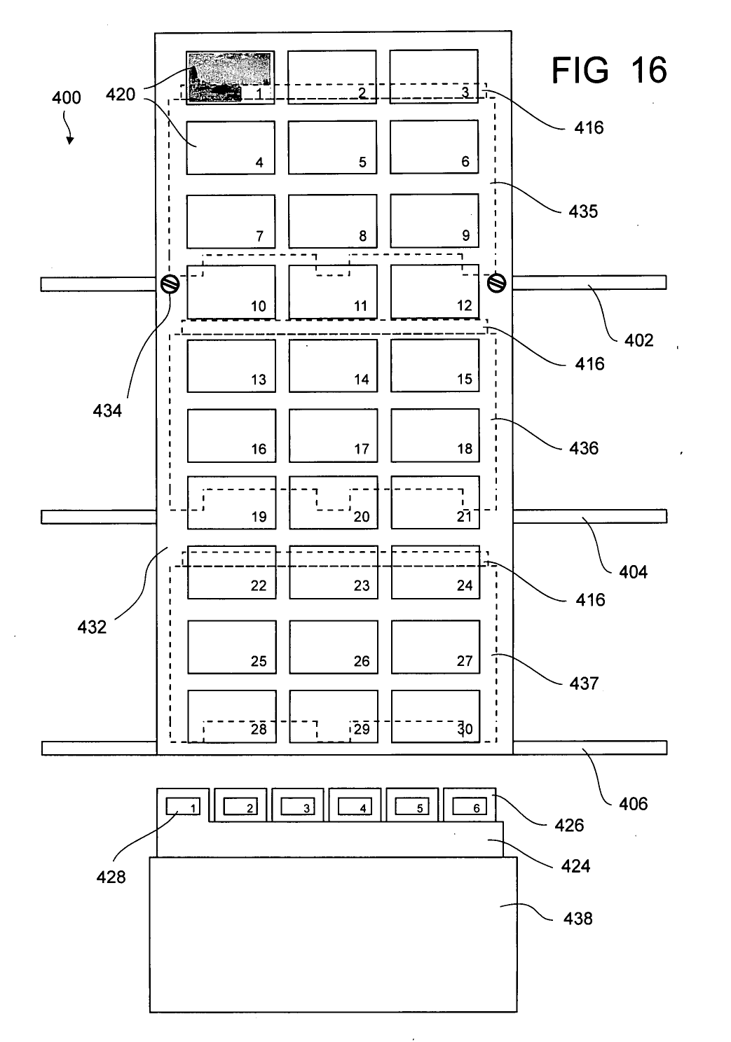

FIG. 16 shows one other example of displaying the small pictures 420 in this frontal space. In this case the shelves 402, 404 and 406 are covered by a large flat panel 432. Two screws 434 are employed for fastening this panel 432 onto the shelf 402.

It is seen here a total of thirty small pictures can be displayed on the panel 432. This is an improvement over the shelf stand 400 shown in FIG. 15 in which only eighteen small pictures of the same size can be displayed. This means that more different art sheets can be previewed and browsed which may lead to more art sheets sold per unit area store floor space. This improvement is achieved with the use of the flat panel 432 which allows the available frontal space to be more efficiently utilized.

As seen in FIG. 16, behind the panel 432 are three outer boxes 435, 436 and 437 placed on the shelves 402, 404 and 406, respectively. Each outer box will hold ten (10) inner boxes 416. This will enable a total of thirty (30) different art sheets 418 to be stored in these outer boxes with thirty (30) corresponding small pictures displayed on the panel 432.

Also shown in FIG. 16 is a display box 438 which can be placed either in front of the shelf stand 400 or underneath the shelf 406. This display box will hold thirty (30) divider cards 424. With four art sheets initially placed behind each divider card 424 a total of 120 art sheets will initially be placed in the display box 438 accessible to a shopper.

It is noted that each of the thirty small pictures on the panel 432 is accompanied by a number ranged from 1 to 30. This number indicates the exact location of the corresponding art sheet stored in the display box 438. It should also be noted that even without these numbers the very orderly arrangement of these small pictures may still reveal the approximate location of each corresponding art sheet in the display box 438. If the shopper is willing to count he would also find the divider card corresponding to the small picture he is interested in.

The fact that during the store opening hour the outer boxes 435, 436 and 437 and all art sheets stored in these outer boxes are covered behind the flat panel 432 is not a problem because all these art sheet are not accessible to store customers anyway. But it does require one additional step of removing and installing the panel 432 whenever the store operator is called upon to restock the art sheets after one particular art sheet in the display box 438 is sold out.

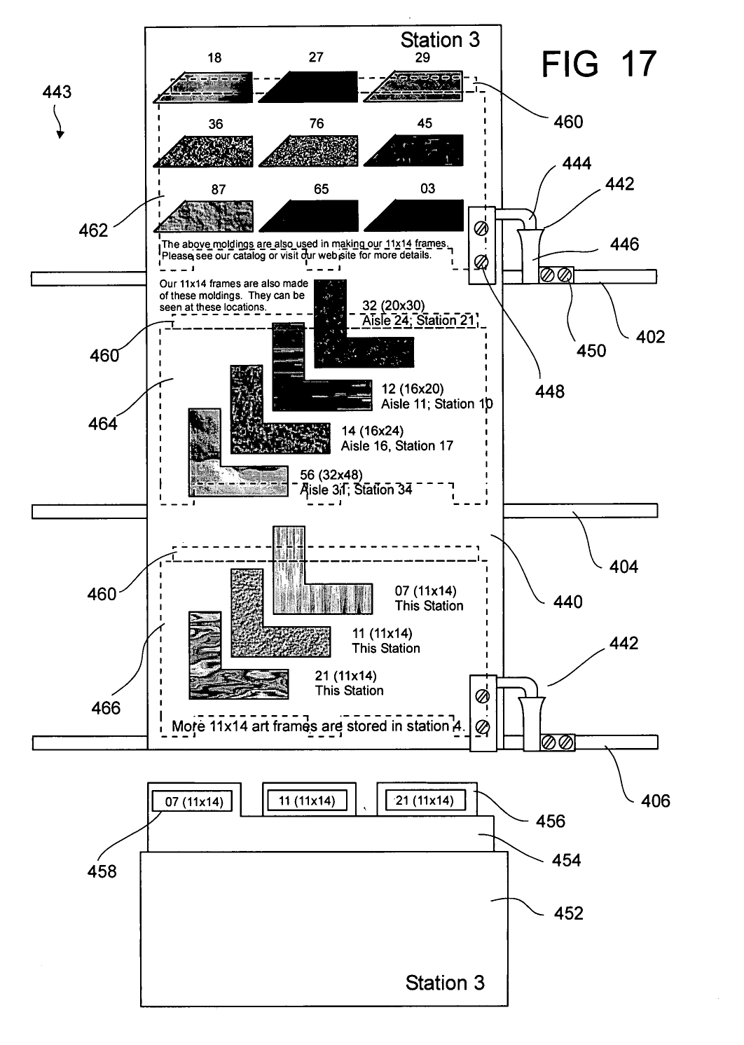

FIG. 17 shows, among others, a flat panel 440 which is similar to the flat panel 432 in FIG. 16. This panel 440 can also be used to display the same thirty small pictures as shown in FIG. 16.

Instead of using two screws 434 for holding the panel 432 in the shelf station 400, two hinges 442 are now employed as shown in FIG. 17 for rotatably mounting the panel 440 on the shelf station 443. Each hinge 442 comprises a hinge stem 444 and a hinge seat 446, mounted on the panel 440 and the shelves using screws 448 and 450, respectively. It is seen that each hinge stem 444 is inserted into and supported by the corresponding hinge seat 446. With this hinge design, the panel 440 can simply be swung open when the store operator needs to get access to the outer boxes 435, 436 and 437. This panel 440 can also be lifted by lifting the hinge stems 444 out of the hinge seats 446. This operation may be necessary when the panel 440 needs to be lowered for service such as changing the display on the panel 440.

Beside art sheets the most important item to be carried in the art store will be the art frames. Because of its bulkiness the storage and display of art frames of various sizes may take up quite some space in an art store. Before going into details of the storage and display issue of art frames which is shown in FIG. 17, it is helpful to make some assumption for a hypothetical case. The basic element in making an art frame is the frame molding. It is first assumed that the present company has a total of 99 different frame moldings from which art frames of several standard sizes will be made. Each molding is an art by itself and should be assigned an artistic name. But for simplicity each molding is simply assigned a number ranged from 01 to 99. Each standard sized art frame will be given a name such as “07(11×14)”, which means a 11″×14″ (28 cm×36 cm) art frame made from the molding 07. In the present example it is assumed that a customer has just purchased several 11×14 art sheets and needs a 11×14 art frame.

It is next assumed that 32 moldings out of the 99 moldings have been selected by the company in making 32 different 11×14 art frames. Due to their bulkiness only 6 different 11×14 art frames are carried by the art store while all others can be ordered through the store or from the Internet. The shelf station 443 shown in FIG. 17 (assigned as station 3) is one of the two stations storing these six art frames. A display box 452 can be placed either in front of the shelf stand 443 or underneath the shelf 406. This display box 452 initially carries three each of the three art frames 07(11×14), 11(11×14) and 21(11×14). A divider card 454 is placed in front of each of the three groups of art frames. Each divider 454 has a tab 456 which carries a thumb tag 458 identifying the art frame carried. All these art frames in the display box 452 are accessible to customer browsing and retrieval. Additional art frames 460 are stored in three boxes 462, 464, and 466 held on the top shelves 402, 404 and 406, respectively, un-accessible to customers.

The three corner samples displayed at the bottom of the panel 440 are for the three art frames stored in this station. Customer can view these three corner samples first before deciding whether to flip the divider cards 454 in the display box 452 to examine the actual art frames available. Customer can also walk to the next station to see more choice of the available 11×14 art frames.

As above assumed, there are 26 art frames not carried by the art store and must be ordered through the store or Internet. However, in 8 out of these 26 art frames, the frame moldings are also used in making other art frames of sizes not 11×14 that happen to be carried in this art store. The mid section of the panel 440 shows four corner samples of such art frames along with information on their frame sizes and location (aisle no. and station no.). Customer may walk to these locations to touch and feel these frames in order to decide whether to place the order.

18 moldings used in making 18 11×14 art frames are not available in any size art frames carried by the art store. On the top section of the panel 440 nine molding samples of such 11×14 frames are displayed. The other nine molding samples are displayed in the other station carrying the 11×14 art frames. These displays will allow customer at least a look of these molding samples before making the order decision.

Instead of displaying the corner samples of the art frames, it is also possible to display a small picture for each art frame just like the case of art sheets. For example, each corner sample can simply be a photo of the corner sample cut out to the shape as shown in FIG. 17. In order to make sure it is easily seen at a distance, each such photo or small picture should have a size more than one hundredth ( 1/100), and preferably one twentieth ( 1/20), of that of the actual art frame stored in the display box 452. It is less costly in comparison with the corner sample display.

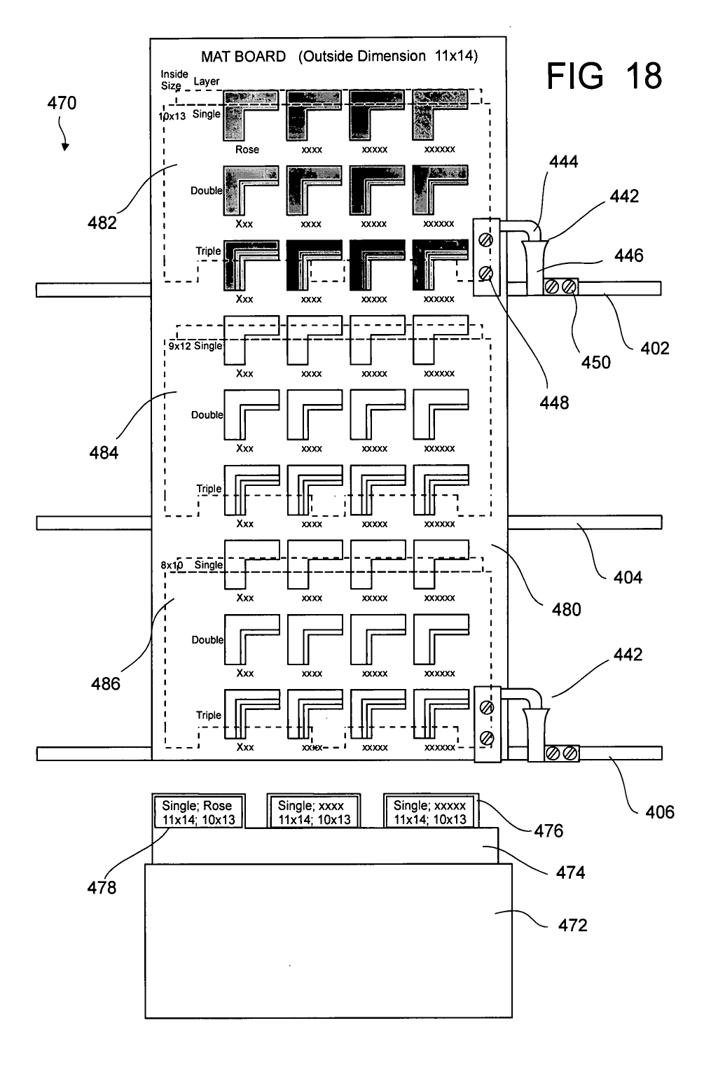

After the purchase of the art sheets and the art frame the next item on the mind of the purchaser may be the mat boards to be placed in the art frame. When the sizes of the purchased art sheets are the same as the internal size of the art frame no mat board may be needed. But if the art sheets are smaller than the art frame one or more mat boards may be needed to properly display each art sheet behind the mat board of appropriate opening sizes. It is assumed that the retail store will carry art sheets of three standard sizes of 10″×13″ (25 cm×33 cm), 9″×12″ (23 cm×30 cm), and 8″×10″ (20 cm×25 cm). Although art frames of these three standard sizes are also available in the store, the shopper may decide to use a 11″×14″ (28 cm×36 cm) art frame to display all these purchased art sheets of smaller sizes. The mat boards stored in the shelf stand 470 shown in FIG. 18 will be needed for the display of these art sheets in a 11′×14″ art frame.

The shelf station 470 shown in FIG. 18 may carry the entire inventory of the 11×14 mat boards by this art store. There are three inside dimensions, 10×13, 9×12 and 8×10, available for the 11×14 mat boards carried by the store. For each inside dimension the mat boards of single mats, double mats, and triple mats can be chosen by the shoppers. The next choice for the customer is the styles of the mat boards that include the color, graphic pattern, etc. of the mats.

Each unique style of the mat boards may be assigned with a name such “Rose”. The complete name assigned for this mat will be (Single; Rose; 11×14; 10×13) which refers to a single mat with Rose style and with 11×14 outside dimension and 10×13 inside dimension. Other choice may also be possible such as the material and thickness of each mat sheet but not considered in the present example.

A total of 36 different 11×14 mats are available in the present example. Three mats in each mat group for a total of 108 11×14 mats are initially placed in the display box 472 accessible to customer browsing and retrieval. This display box 472 can be placed either in front of the shelf stand 470 or underneath the shelf 406. A divider card 474 is placed in front of each mat group. Each divider card 474 has a tab 476 on which a thumb tag 478 showing this mat group's name is applied.

A corner sample for each of the 36 mat boards is displayed on the panel 480. This panel 480 is similar to the panel 440 shown in FIG. 17 and is hinged to the shelf station 470 using two hinges 442 identical to the hinges 442 shown in FIG. 17.

Instead of displaying the corner samples of the mat boards, it is also possible to display a small picture for each mat board just like the case of art sheets. For example, each corner sample can simply be a photo of the corner sample cut out to the shape as shown in FIG. 18. In order to make sure it is easily seen at a distance, each such photo or small picture should have a size more than one hundredth ( 1/100), and preferably one twentieth ( 1/20), of that of the actual mat board stored in the display box 472. It is less costly in comparison with the corner sample display.

More mat boards are stored in three mat boxes 482, 484 and 486 held on the shelves 402, 404 and 406, respectively behind the panel 480. The mat boards stored in these mat boxes 482, 484 and 486 are un-accessible to the shoppers. The store operator can get access to them by simply first rotating open the panel 480.

The large frontal space required by these panels are ideally fulfilled by the shelf stations 400, 443 and 470. Each of these stations has a lower section and an upper section. The upper section of each of these shelf stations has at least two and preferably three or more shelves in order to provide the needed large frontal space for the panels 432, 440 and 480. These upper sections are needed for storing the art sheets, art frames and mat boards not accessible to the store customer but can be accessed by the store operator by simply swinging open the panels at the front.

The lower section can also be used for general storage if the display boxes 422, 438, 452, and 472 are placed on the floor outside of the shelf station. But this lower section must be made available for housing the display box if the box is placed beneath the shelf 406 or placed on a flat bed with rollers which may need to be rolled in during certain occasions.

In summary, the panels 432, 440 and 480 shown in FIGS. 16, 17 and 18, respectively, provide valuable information. It will familiarize each visitor on the art sheets, art frames and mat boards available in the arts store, and also in the company's web site. The samples openly displayed on the panels may eliminate much unnecessary labor by the shoppers in flipping through the extensive inventory. And more importantly, it will enable shoppers to quickly find and get the art supplies they like and need without much manual labor.

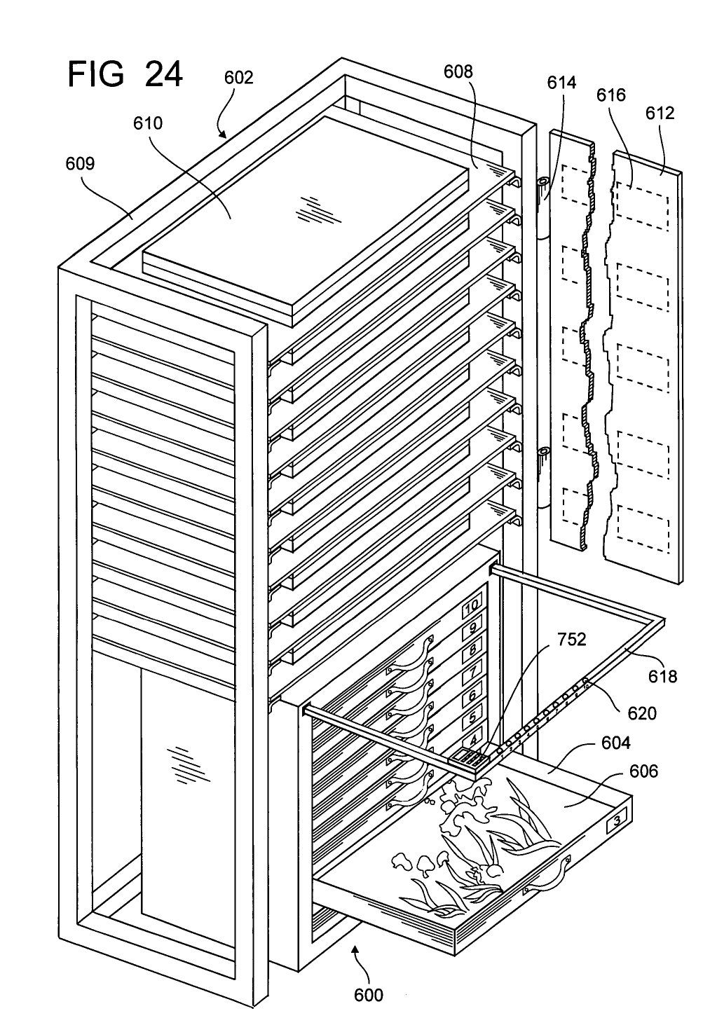

FIGS. 24-27

The conventional method for selling art sheets by placing them in a box is really not ideal. First, for ease of handling, each art sheet is usually supported by a cardboard and wrapped in a transparent wrapper. When considering so many art sheets to be stocked in an art store the extra space taken up by these cardboards will severely limit the number of copies of each art to be stocked for sale. It will naturally lead to very frequent restocking and enormous manpower drain. In a display box with tightly stocked art sheets, it may be difficult to fully open up the stack to have a closer look of the art sheet of interest.

It is proposed that instead of boxes of art sheets a drawer stand with multiple drawers be employed. Shown in FIG. 24 is one such drawer stand 600. It is placed inside a shelf stand 602. The drawer stand 600 is shown with ten drawers 604. But for a 4 ft or slightly taller drawer stand it can have up to forty (40) drawers. Each drawer can hold up to fifty (50) identical art sheets 606, unwrapped and without cardboard support. Positioned above the drawer stand 600 are ten removable shelves 608 in the shelf stand 602. But for a big box retail store with a 10-ft or higher ceiling the available space in the shelf stand above the 4-ft drawer stand may accommodate up to forty (40) removable shelves.

As seen in the figure, each shelf 608 holds two packs 610 of art sheets. The art sheets in these ten shelves 608 are identical to the art sheets stored in the ten drawers 604, respectively. Each pack of art sheets may hold forty (40) identical art sheets. This means that when the content of any drawer 604 is down to ten or less art sheets it should be refilled with one art sheet pack 610 from the corresponding shelf 608. Since each art sheet carries a bar code, the store management will know quickly through its sales record which drawer will need a refill soon.

Also shown in FIG. 24 is a front panel 612 rotatably supported on the shelf stand frame 609 with two hinges 614. This front panel 612 is normally in the closed position covering the shelves 608. A plurality of small pictures 616 are posted on this front panel 612 to show all art sheets stored in the drawer stand 600 available for customer examination. In order for these small pictures 616 to be seen at a distance the size of the small picture must be at least one hundredth ( 1/100), preferably one twentieth ( 1/20) of that of the corresponding art sheet. The drawer number is also posted next to each small picture showing in which drawer the actual art sheet is located.

Once the art sheet of interest is identified by viewing the small picture panel 612, the shopper can pull open the corresponding drawer 604 to examine the actual art sheet itself. With the drawer 604 in the open position, the art sheet 606 is laid flat fully exposed away from the shelf stand 602. The shopper can leisurely feel and touch the art sheet. If interested, the shopper can easily take out one sheet for purchase. The store needs to provide customer an open-top cardboard box or tray to be placed on a shopping cart for holding all art sheets to be checked out.

As shown in FIG. 24, a “U”-shaped guard 618 is telescopingly built into the drawer stand 600 at its top. It can be manually pulled out to prevent the shoppers from stepping into the space needed for free movement of any drawer. This is desirable especially when the movement of these drawers is to be remotely controlled to be described below. Shoppers can stand around this guard 618 for viewing the art sheet in the drawer pulled out of the drawer stand. This guard 618 can be pushed in if at any time the guard is interfering with the retrieval or viewing of the art sheet.

With proper engineering design the present drawer stand can be electrically controlled to be opened and closed. Installed on the guard 618 are ten push button switches 620, each of which is for controlling the operation of one of the ten drawers 604. A push of one switch 620 will cause the corresponding drawer to be opened. A push again of this same switch 620 will close the currently opened drawer. Such forward/reverse select switch 620 is well known in the prior arts such as the wall switch used in garage door opener. One push of this switch will open the garage door, and a second push of this switch will close this garage door.

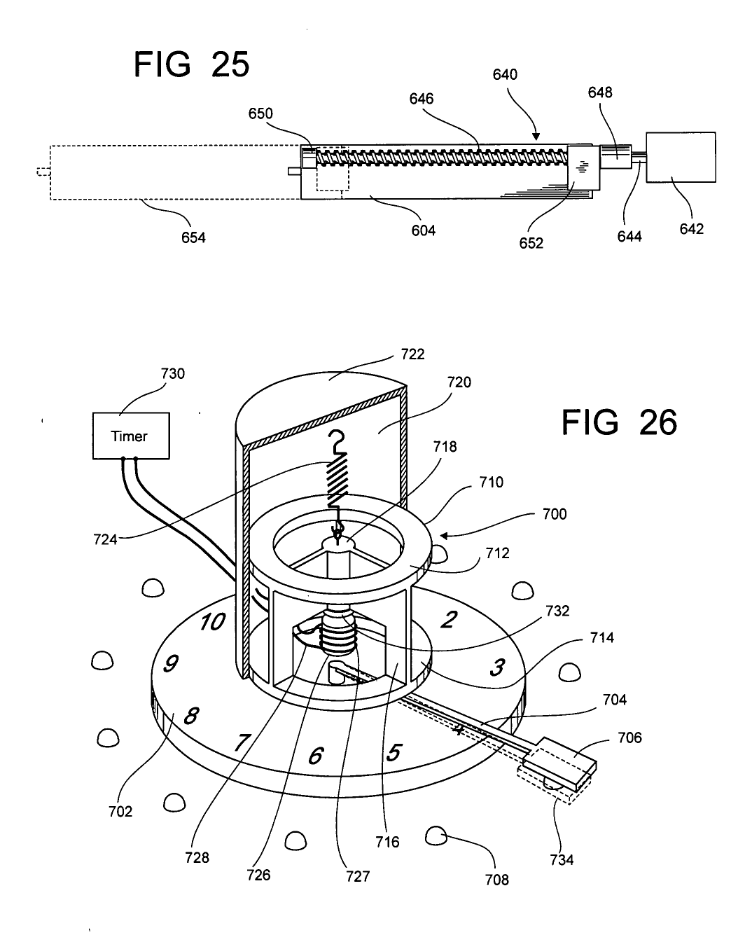

FIG. 25 shows a screw drive type of operator 640, also known in garage door opener, for opening and closing the drawer 604 in the drawer stand 600. It mainly comprises a reversible motor 642 having a rotatable shaft 644. An elongated screw rod 646 is joined to the shaft 644 with a sleeve coupling 648 and be rotatable along with the shaft 644. The reversible motor 642 is supported on the drawer stand 600. The front end of the screw rod 646 is covered by a cup 650. This cup 650 is rotatably supported on the drawer stand 600 with some ball bearing supporter.

The drawer 604 may have several rollers of conventional design and be slidably supported on the drawer stand 600. A nut member 652 is shown, which has threaded opening and in engagement with the screw rod 646. This nut member 652 is fastened to the drawer 604 with fasteners such as screws, not shown. The rotation of the screw rod 646 will therefore cause a sliding motion of the nut member 652 as well as the drawer 604.

Each of the ten drawers 604 in the drawer stand 600 is equipped with a drawer operator 640. A push of the forward/reverse select switch 620 will activate the drawer operator 640 and open the drawer 604 to the position as shown by the dash line 654. A push again of the same switch will close the drawer 604 to its original position as shown in FIG. 25.

An operator of other type of drives can also be incorporated for driving the opening/closing of the present drawers 604. An example of one such drive is a chain drive. A chain type drive and reversible motor used in a garage door opener is also known in the prior arts.

The capability of electrically opening each drawer 604 when desired is especially useful when it is in conjunction with the display of small pictures 616 on the front panel 612. By viewing these small pictures the shopper will quickly notice one picture of interest to him. This is followed with a simple push of one forward/reverse switch 620 to open the drawer displaying this picture. The shopper can leisurely examine this picture. If interested he can remove one sheet for purchase. This is the most easy and enjoyable way to quickly find one picture of interest and obtain it for purchase. No flipping through a large pile of art sheets is needed.

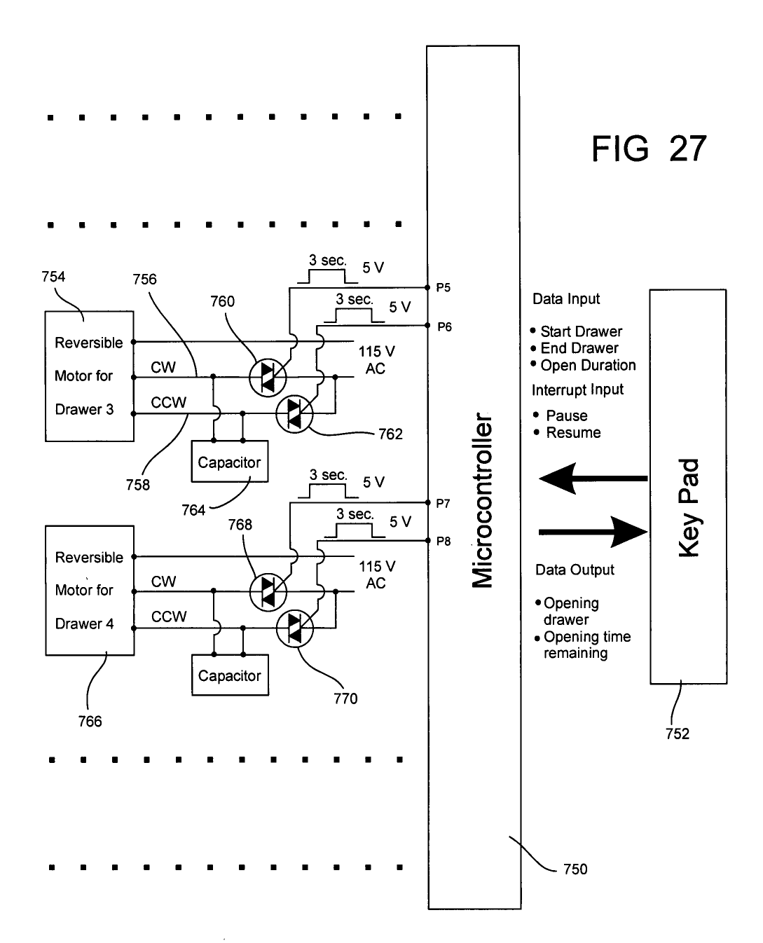

For purpose of illustration, FIG. 26 discloses a machine 700 which can be activated to display an art sheet in each of the ten drawers 604 of the drawer stand 600 for five seconds starting from the art sheet in the drawer 1. This machine 700 comprises a clock of conventional design. No hour or minute arm is needed here. A long second arm 704 is shown with a rectangular plate 706 at its front end. This flexible second arm 704 will be bent downward when it is pressed but will return to its original position when the pressing force is removed.

Also included in this machine 700 are ten forward/reverse select switches 708. Just like the switches 620, these switches 708 are also wired to open and close the ten drawers 604 of the drawer stand 600. One switch 708 is placed next to one number on the clock 702 for operating one drawer 604 of the same number.

Positioned above the clock 702 is a one-piece molded plastic ring member 710. This ring member 710 is composed of two spaced apart ring plates 712 and 714, interconnected by three vertical plates 716 in the shape as shown in the figure. Integrally joined to these three vertical plates 716 is a rod-like stud 718. The ring member 710 is enclosed within a stationary hollow cylinder 720 with a top cover 722. Part of this cylinder 720 is cut off to reveal the details of the ring member 710. The ring member 710 is slidable along the inside wall of the cylinder 720. The ring member 710 is hung by a tension spring 724 on the top cover 722. The gravity of this ring member 710 will maintain it at a position just above, but not touching, the second arm 704 of the clock 702.

Located between the stud 718 and the second arm 704 is a stationary iron rod 726 wrapped by an electromagnetic coil 727 of several turns of the wire 728. The stationary iron rod 726 is mounted on the cylinder 720 by some arm members not shown. An iron disk 732 is shown fastened to the bottom of the stud 718 spaced apart by a small gap from the iron rod 726.

As seen in FIG. 26, the wire 728 is connected to a timer 730 of conventional design. This timer is programmed to send a burst of current every five seconds to the electromagnetic coil 727. During this time the iron rod 726 becomes magnetic and attracts the iron disk 732 as well as the entire ring member 710 to itself against the tension spring 724. As seen in the figure, the downward motion of the ring plate 714 will cause it to hit the second arm 704 and bend it to its new position as indicated by the dash line 734. If at this time the rectangular plate 706 is happen to be right above the switch 708 for the drawer 4, the switch 708 will be pressed and cause the drawer 4 to be opened. The second arm 704 is regularly rotating at the rate of one revolution per minute. Right at the moment when the second arm 704 is positioned at the number 12 the timer 730 is activated. From this point on the timer will send out one burst of current every five seconds. At the fifth second the drawer 1 will be opened. At the tenth second the drawer 2 will be opened. The program continues until at the 50th second when the drawer 10 will be opened. At any time only the art sheet in the newly opened drawer will be displayed. All art sheets in the drawers below will not be visible in spite of the open condition of these drawers.

It is interesting to note that if the timer 730 is allowed to continue its operation beyond the first minute, all drawers will be closed one by one starting from the drawer 1 at the fifth second of the second revolution cycle of the second arm 704. It is also interesting to note that the art sheet in the drawer 10 will be visible until the drawer 10 is closed.

The machine 700, in spite of its primitive design, is successful in performing a real “picture show” to enable an art sheet in each of the ten drawers of the drawer stand 600 to be sequentially displayed for a pre-determined time period. However, this machine 700 is impractical because it lacks many features a viewer would desire in a picture show. The change of display duration for each art sheet is difficult unless by changing the clock gear structure. Very often the viewer may want to halt the picture show in order to spend a little more time to examine the art sheet currently on display and to remove one art sheet for purchase. At the end of this examination the picture show will then resume.

FIG. 27 is a schematic electronic circuit diagram for a computer based system for performing the picture show above described. The central element of this system is a microcontroller 750 which houses an onboard central processing unit (CPU). The second element is a key pad 752 which can be located on the U-shaped guard 618 of the drawer stand 600 in FIG. 24 for interaction with the viewer and the microcontroller.

The computer program needed for running this microcontroller 750 is not shown here. But it can be written by a person familiar with microcontroller and with experience of writing a program for such microcontroller upon given the required tasks to be carried out.

As shown in FIG. 27, a capacitor-run AC motor is chosen for operating each of the drawers in the drawer stand 600. The time for opening or closing each drawer is assumed to be 3 seconds. This means that after opening or closing each drawer the power applied to all motors will be cut off and all drawers will stay in their existing opened or closed position unchanged for the remaining time of each drawer operation cycle.

In FIG. 27 the circuit diagrams for operating the drawers 3 and 4 are shown. The circuit diagrams for the other eight drawers can also be similarly designed. In the circuit diagram for the drawer 3 a reversible AC motor 754 for drawer 3 is shown. It is powered by a single phase 115 V AC line. One leg of this AC line is split into two lines connected to two different motor internal wiring. The wire 756, when activated, will cause a clockwise (CW) rotation of its motor shaft which in turn will move the drawer 3 forward for its opening. The wire 758, when activated, will cause a counterclockwise (CCW) rotation of its motor shaft which will in turn move the drawer 3 backward for its closing. Only one of the two wires 756 and 758 can be activated at a time.

In FIG. 27 a triac 760 is placed in the AC wire 756 and an identical triac 762 is placed in the AC wire 758. These triacs are relays commonly used for controlling the bidirectional flow of AC current. A three second 5V pulse can be supplied from the pin P5 of the microcontroller 750 and applied to the gate lead of the triac 760 to open the AC current flow for three seconds for opening the drawer 3. Similarly, a three second 5V pulse can be supplied from the pin P6 of the microcontroller and applied to the gate lead of the triac 762 to open the AC flow for three seconds for closing the drawer 3. A capacitor 764 is added to improve the startup of the AC motor.

The circuit diagram for the drawer 4 is essentially identical to the circuit diagram for the drawer 3 above-described. A reversible motor 766 for drawer 4 is employed for opening/closing the drawer 4. A triac 768 with its gate pulse coming from the pin P7 of the microcontroller 750 is used for turning on the AC current and opening of the drawer 4. A triac 770 with its gate pulse coming from the pin P8 of the microcontroller 750 is used for turning on the AC current and closing of the drawer 4.

The operation of the present computer based system can be explained by a following example. After viewing the small pictures 616 on display on the front panel 612, the viewer wants to view a picture show starting from the art sheet in the drawer 4 and ending at the art sheet in the drawer 9. The duration of display for each art sheet is ten seconds. The viewer next then keys in these information into the key pad 752. This is followed by pushing the “go” button or other designated button to start the picture show.

Upon receiving the data input and the start signal from the key pad 752 the microcontroller 750 will start its picture show program. Before opening any drawer all other drawers presently opened must be closed. Since the microcontroller 750 “remember” the drawer 3 is currently open as shown in FIG. 27, it will first close this drawer at the same time it open the drawer 4. This is done by simultaneously sending a three second 5V pulse to the triacs 762 and 768 from the pins P6 and P7, respectively. After the end of this three seconds the drawer 3 will stay closed indefinitely while the drawer 4 will stay open only during the next seven seconds.

During the second ten second cycle the drawer 4 will be closed while the drawer 5 will be opened. The process will continue until the drawer 8 is closed while the drawer 9 is opened. From then on the drawer 9 will remain open until another program starts.

It is also possible to modify the present program to allow for more features desired by the shoppers. For example, it will allow the shopper to pause the present picture show. The presently opened drawer will stay open indefinitely to allow viewer more time to examine the art sheet on display and to remove one art sheet for purchase.

Once the pause button is pushed by the shopper, an pause interrupt signal is transmitted from the key pad 752 to one interrupt inlet pin of the microcontroller 750. One task of the microcontroller program is pre-written to monitor the presence of the interrupt signal coming in through the interrupt inlet pin. At the presence of such signal one pre-written subroutine is called upon to handle this interruption. First, the present picture show is halted. All gate voltage from the pins of the microcontroller are cut off which will in turn cut off any AC current to the motors of the drawers indefinitely. This means that all drawers of the drawer stand 600 will be frozen at its open, or closed position at the moment the pause signal was sent. But in the mean time the microcontroller will be directed to keep note on its present status so it will know how to resume its picture show once the interruption is terminated.

There may be a case for example when the pause signal was sent a little bit too late, at which time the drawer 7 is on its way to be closed, and the drawer 8 is already half open. Clearly, the shopper's intention is to hold the drawer 7 in its open position in order to give him more time to examine the art sheet in the drawer 7. Upon receiving the pause signal at this time the interruption subroutine can cut off the gate pulse closing the drawer 7, which is followed by sending a new gate pulse for opening the drawer 7. In the mean time, the gate pulse for opening the drawer 8 will be cut off, which is followed by sending a new gate pulse for closing the drawer 8.

The termination of the pause interruption is normally initiated by the shopper by pushing a “go” or other designated button on the key pad 752. This will cause the key pad to send yet another interrupt signal to the microcontroller 750 at an interrupt pin different from the first interrupt pin. At the presence of this interrupt signal a yet another subroutine program will be called upon to handle this interruption of the first interrupt. The status of the picture show program just before the first interruption will be recalled and the clock of the picture show will start ticking again for resuming the picture show.

With the establishment of the present computer based system the forward/reverse select switches 620 previously installed on the U-shaped guard may have to be removed. This is because that the operation of these switches 620 may interfere with the operation of the microcontroller 750. It is possible to redesign and rewire these switches by incorporating them as part of the microcontroller operation. One possible solution is to build each drawer switch as a separate interrupt line to the microcontroller 750. Upon receiving this interrupt signal the microcontroller will halt its current program. The selected drawer will be opened while all other drawers will be closed at the same time.

The ability to view a large number of art sheets in the present picture show opens up a new way of finding and obtaining an art of interest through chance encountering. Since minimum hand labor is involved, one is more likely to stay longer to view one or more such picture shows which would greatly improve the chance of such encountering. The present picture show is like the conventional slide show commonly seen displayed on a computer monitor or TV. But the difference is that here the actual art sheets are viewed. Once an art is found of interest, it can be taken out for purchase.

It is even more efficient when the present picture show is combined with the small pictures display. Very often small pictures are grouped together by either their artists or categories. The small pictures display thus become a pre-screening tool for deciding which group of art sheets are to be selected for picture show. This technique will be preferred by art buyers choosing arts according to their artists and/or categories.

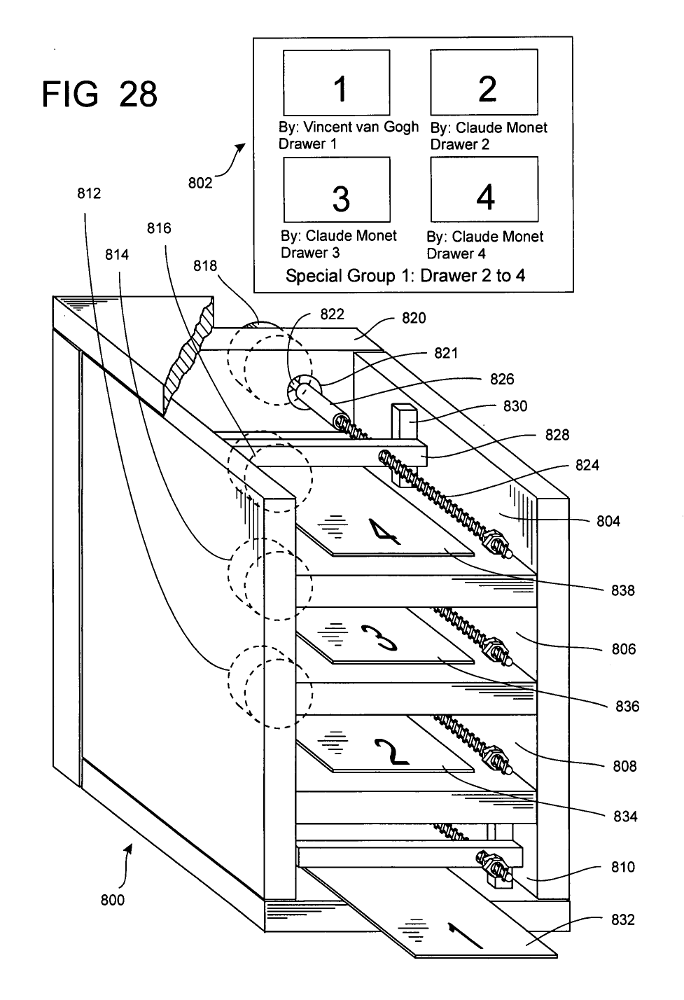

FIGS. 28-30

FIG. 28 shows a prototype drawer stand 800 and an associated small picture panel or sheet 802. This prototype drawer stand is basically a box with four open slots 804, 806, 808, and 810 on its front side. Four motors 812 (M1), 814 (M2), 816 (M3), and 818 (M4) are installed on the back side of the back plate 820 of the drawer stand 800. Only one motor M4 is partially seen in FIG. 28.

As seen in FIG. 28 a clearance hole 821 is provided on the back plate 820 for clearing the shaft 822 of the motor 818. This shaft is joined to a threaded rod 824 with a coupling 826. A horizontal bar 828 with a threaded hole is in engagement with the threaded rod 824. A vertical bar 830 is glued or fastened to the horizontal bar 828 to limit the rotation of the horizontal bar 828.

There are four drawers 832, 834, 836, and 838 installed in the prototype drawer stand 800. The drawer 4, 838, is actually just a small picture card fastened to the horizontal bar 828. Similar to the screw type operator 640 shown in FIG. 25, the rotation of the threaded rod 824 driven by the motor 818 will in turn drive the non-rotating horizontal bar 828, and the drawer 4, 838, in and out of the prototype box 800. The drawers 1, 2, and 3 are similarly driven by the motors 812, 814 and 816, respectively. The drawer 1, 832, is shown in the open position while the drawers 2, 3, and 4 are in the closed position.

These four motors 812, 814, 816 and 818 are stepper motors which rotate in steps with high precision. The actual motors chosen for this prototype are 12 volt DC unipolar motors (Model 42M100B2U) from Danaher Motion, Redford, Va., for hobby use. In the present work these motors are operated at 18 volts in order to increase the torque. Obviously, for a real world electric drawer a motor with more powerful torque will be required.

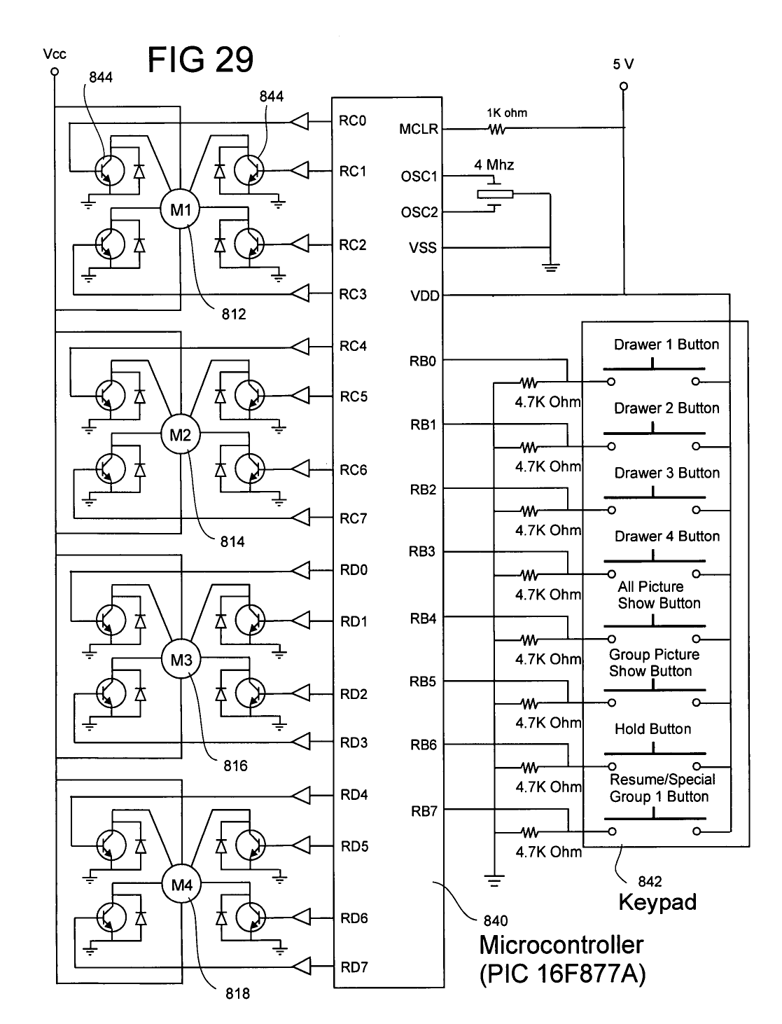

FIG. 29 is a schematic electronic circuit diagram of a computer based system for operating the prototype drawer stand 800. The central component is a microcontroller 840. The one chosen for this prototype is a 40-pin controller (PIC16F877A) from Microchip Technology Inc. (Chandler, Ariz.). It is powered by a regulated 5V DC source and operated at 4 MHz. 16 pins from the controller's Port C (RC0 to RC7) and Port D (RD0 to RD7) are used for controlling the operation of the four motors 812, 814, 816 and 818.

A home-made keypad 842 is also shown in FIG. 29. It houses eight push buttons for sending signals by a user from the key pad 842 to the Port B (RB0 to RB7) of the microcontroller 840 to request various kinds of operations. Each motor is shown having six electric wires coming out of the motor. Two of them are connected to the DC source Vcc, which in this case is a 12 V or higher DC power source. The other four wires connect the motor's stator coils to four TIP 120 transistors 844. Each transistor 844 is basically an electric switch which will conduct once a 5V voltage is applied to the base of the transistor 844.

With an imbedded computer program, the microcontroller 840 is programmed to send out 5V pulses to the bases of the transistor 844 of the motor 1, 812, through its four pins RC0 to RC3. But only two of these four transistors 844 will receive the 5V pulse at a time. By switching the applied pulses in a timely manner, the motor 812 can be programmed to rotate either clockwise or counterclockwise in a step wise motion. The other three motors 814, 816 and 818 will be programmed to rotate in the similar manner.

The next item to be described is a computer program for performing the picture show of the present invention. There are two picture shows that can be performed by this computer program using the present prototype. The first picture show is termed “Single Picture Show”. Once the store shopper spots a picture of interest shown on the small picture panel 802, he can push a drawer button (Drawer 1 to 4) in the keypad 842 to open the corresponding drawer displaying the actual art sheet of interest to the shopper. This is a Single Picture Show. The drawer will remain opened until other button of the keypad 842 is pushed.

The second picture show is termed “Multiple Picture Show”. There are three kinds of Multiple Picture Shows. The first one is termed “All Picture Show”. The shopper can push the “All Picture Show” button of the keypad 842 to start this show in which all four drawers of the drawer stand 800 will be sequentially opened for ten seconds each. The shopper can push the “Hold” button to hold the presently opened drawer in its open position if he needs more than ten seconds to examine the art sheet displayed in the drawer. At the end of this examination, the shopper can push the “Resume” button to resume the All Picture Show.

The second Multiple Picture Show is called “Group Picture Show” which will sequentially open a group of drawers started from a starting drawer and ended at an ending drawer. After pushing the “Group Picture Show” button the shopper must also push two drawer buttons, designated as the starting and ending drawers in order to start this show. The duration of each drawer opening is again ten seconds during which the shopper can press the Hold button to extend the opening period of the opened drawer. A push of the Resume button will resume the Group Picture Show.

The third Multiple Picture Show termed “Special Group Picture Show” can also be programmed. For example, in a four-drawer stand the Drawer 2 to Drawer 4 will hold the art sheets by Claude Monet and designated as Special Group 1 as shown in the small picture panel 802. If a shopper want to see all art sheets by Monet he can push a special button marked as Special Group 1 which will cause all three drawers to be opened, one drawer at a time, as a Special Group Picture Show. Again, a push of the Hold button will hold the currently opened drawer open beyond the ten second limit, and a push of the Resume button will resume the Special Group Picture Show. It is clear that the Special Group Picture Show is a Group Picture Show but with pre-decided starting drawer and endings drawer. This show is preferable to the regular Group Picture Show for many shoppers because the shoppers will not need to press two more buttons to start this show.

During any Multiple Picture Show, and while no motor is running, a push of any drawer button from drawer 1 to drawer 4 will start a Single Picture Show of the drawer represented by the pressed drawer button. This also means that the program now exits the Multiple Picture Show.

Anytime a drawer is opened, the previously opened drawer will be closed immediately afterward. As seen in FIGS. 24 and 28, the lowest number drawer is Drawer 1 which is located at the bottom of the drawer stand 600 or 800. The highest number drawer, i.e., drawer 10 or 4, is located at the top of the drawer stand 600 or 800, respectively. The Multiple Picture Shows are programmed to begin with opening of the lowest drawer in the drawer stand or in the designated group, and proceeds in sequence until the highest drawer in the drawer stand or in the designated group, is opened. This means that during the Multiple Picture Show the just opened drawer will not be blocked by the drawer just below it and about to be closed.

Listed in Appendix I is a source code of the present computer program operating the present prototype drawer stand. This source code is written in a Basic language called PICBasic, developed by microEngineering Labs in Colorado Spring, Colo. This source code must be compiled into a machine code and uploaded into the microcontroller before it can be operated.

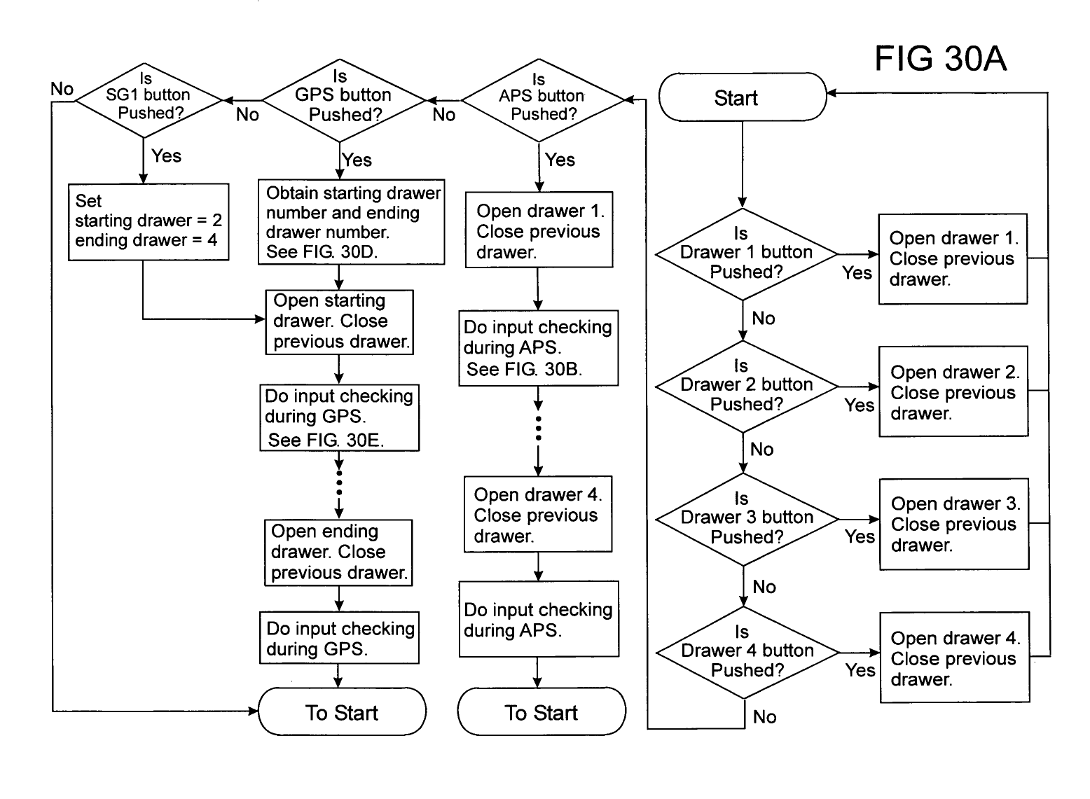

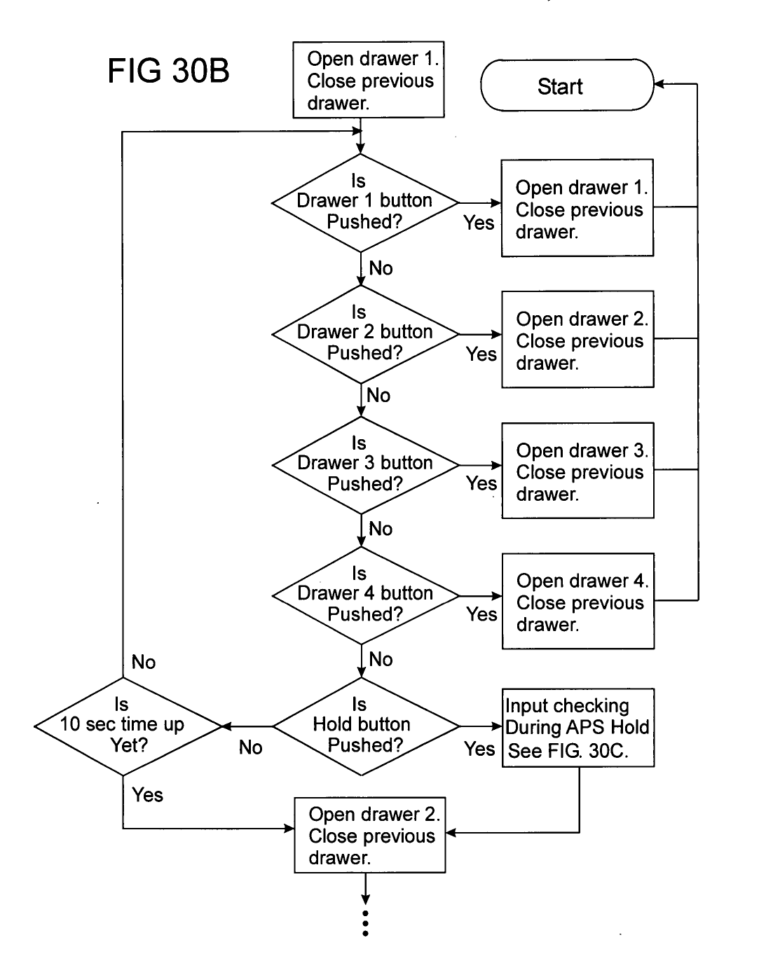

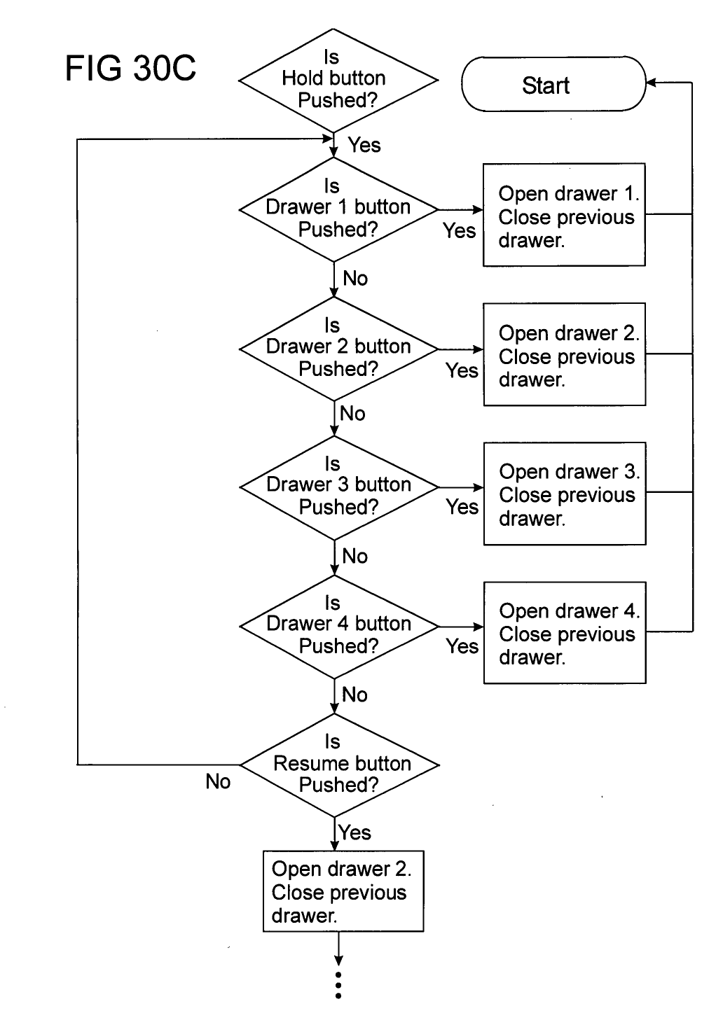

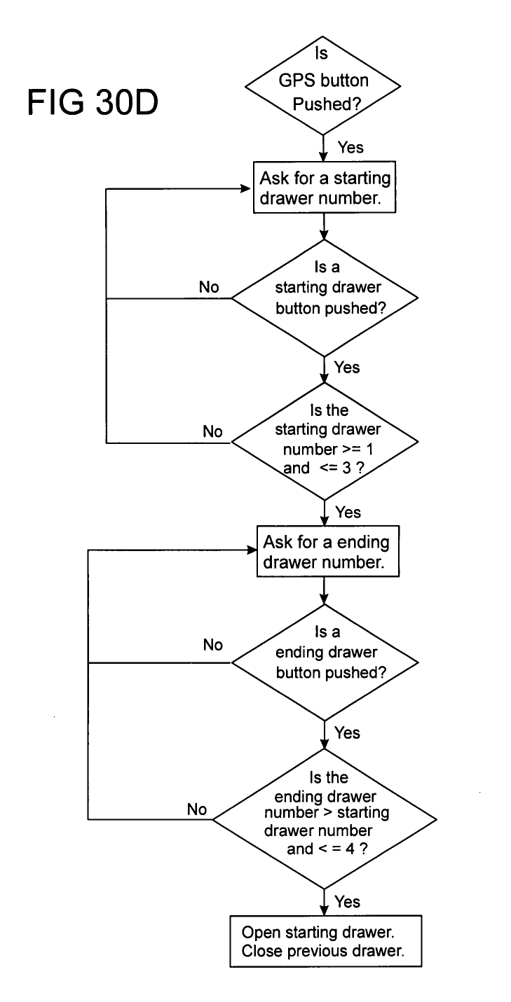

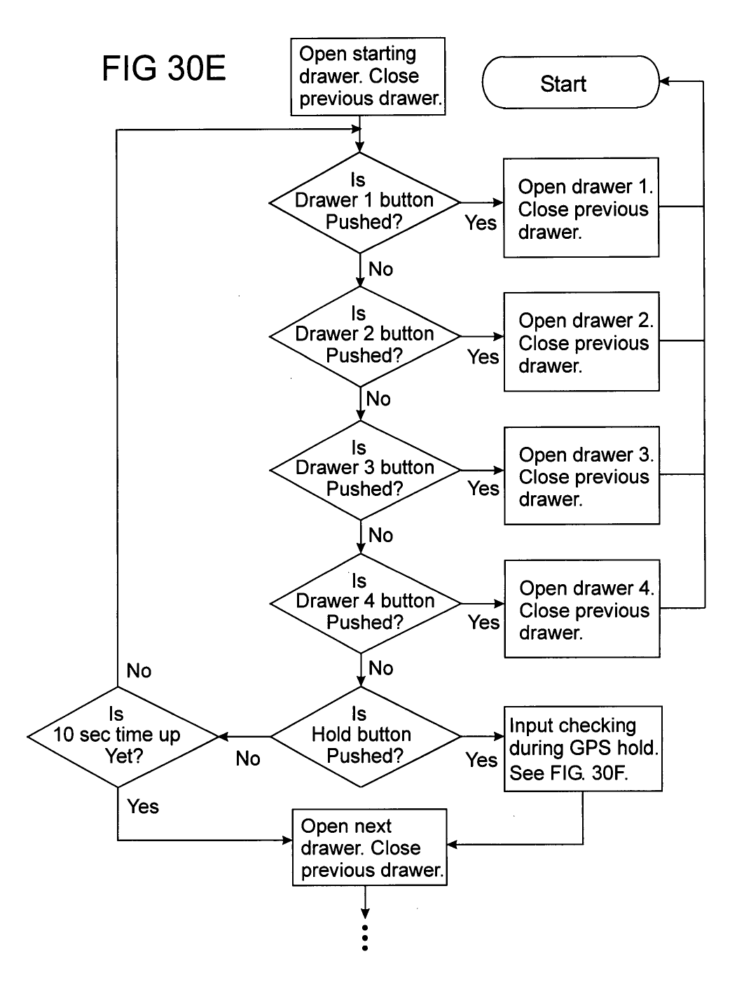

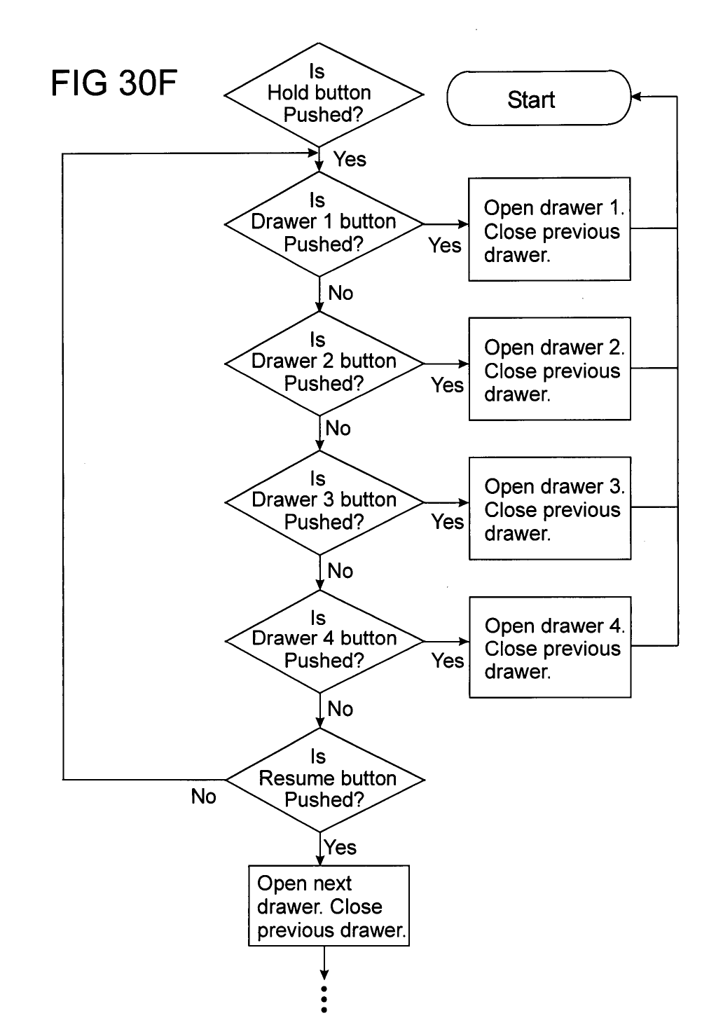

In addition to the source code listing, a flow chart as shown in FIGS. 30A-30F also serves to describe this computer program and the operation of the microcontroller 840 in performing the four above-described picture shows.

The electronic system as shown in FIG. 29 is adequate for the operation of a four-drawer stand. For a forty-drawer stand the required electronic system will certainly be of much larger scale than what is shown in FIG. 29. In the present prototype drawer stand four stepper motors are employed. But other DC motors as well as AC motors can also be similarly employed in the actual drawer stand if desired.

It is desirable, but not absolutely necessary, that a small picture panel 802 be provided for the operation of a Multiple Picture Show. In the case of All Picture Show, instead of the small picture panel, a note that this drawer stand holds Classical 19th century European arts will entice a shopper interested in such arts to initiate an All Picture Show. For a shopper with an open mind and ready to view any arts, one such All Picture Show may also be preferred.

In the case of Special Group Picture Show, a notice providing the information such as the Special Group 1 from drawer 7 to 15 holds the arts by Vincent van Gogh, and the Special Group 2 from drawer 16 to 35 holds the arts by Claude Monet will be needed. A shopper interested in the arts by van Gogh will choose a Special Group 1 Picture Show, while another shopper interested in the arts by Monet may choose a Special Group 2 Picture Show.

In the same example above described, if a person is interested in the arts by both van Gogh and Monet, he may instead press the Group Picture Show button and then press the drawer 7 and 35 buttons as the starting and ending drawers, respectively. Of course he may also press the Special Group 1 button first and then later on press the Special Group 2 button.

With all above said, a small picture panel 802 is still highly desirable in a Multiple Picture Show. The very presence of so many arts on a panel is an attraction in itself. Instead of reading the fine print words about the artists, the shopper is more likely attracted to the posted picture arts. If he sees five or six adjacent arts of high interest he will probably just go ahead choose the Group Picture Show followed by entering the starting and ending drawer numbers of these five or six arts. Without the small picture presentation, there would be no way for him to zero in on these five or six art sheets.

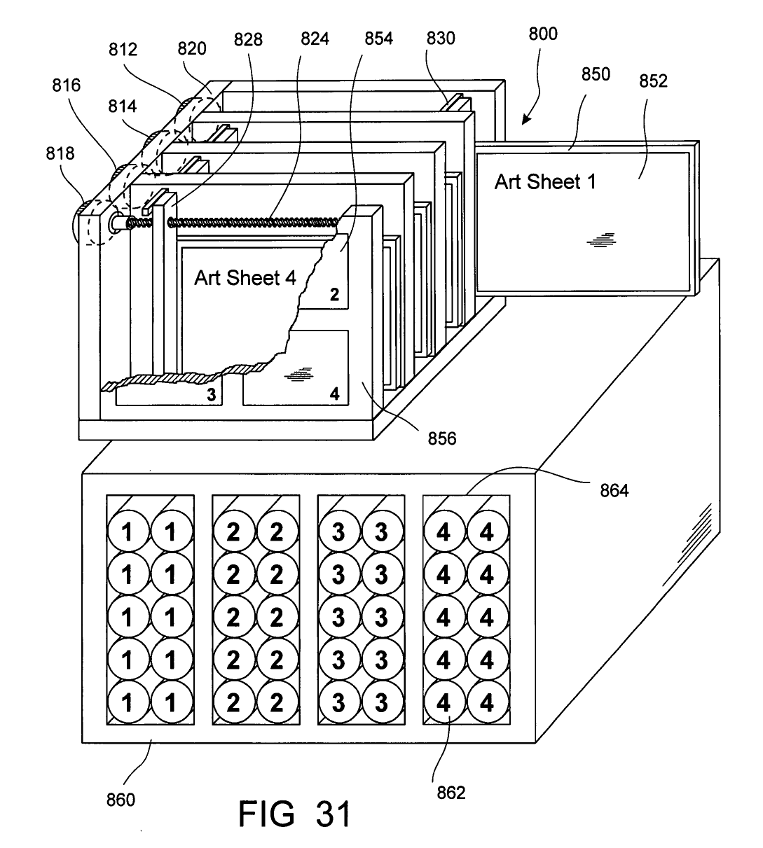

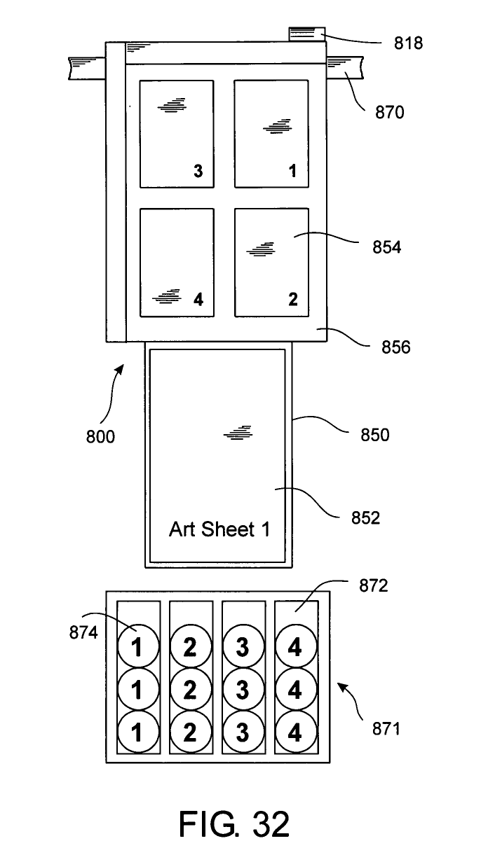

FIGS. 31-32

FIG. 31 shows the largely same prototype drawer stand 800 of FIG. 28, turned 90 degree sideway, and renamed as a display box 800. Four motors 821 (M1), 814 (M2), 816 (M3), and 818 (M4), as well as associated components including threaded rod 824, bar with threaded hole 828, and bar 830 are reproduced in this figure.

The drawer 1 832 in FIG. 28 is changed into an art sheet 852 attached to a plate 850 as shown in FIG. 31. This plate 850 is also fastened to the bar 828 and movable in and out of the display box 800. The drawers 2, 3, and 4 of FIG. 28 are also changed to art sheets 2, 3, and 4 and attached to their corresponding plates partially shown in FIG. 31.

Four small pictures 854 representing the art sheets 1, 2, 3, and 4 are now attached to a sidewall 856 of the display box 800. This sidewall 856 essentially serves as a small picture panel 802 shown in FIG. 28.

Located below the display box 800 is a case 860 for holding the art sheets 1, 2, 3, and 4 individually rolled and stored in the tubes marked as 1, 2, 3, and 4, respectively. This case 860 has four vertical compartments 864, each for holding many tubes 862 of one designated number. This kind of art sheet storage is best suited for storing art posters which are generally very flexible and can be easily rolled. Once removed from the tube the art poster can easily restore to its flat shape for display.

The electronic circuit of FIG. 29 as well as the computer program in Appendix I can be employed for operating the display box 800, for performing the Single Picture Show and Multiple Picture Shows just like in the case of the prototype drawer stand 800 in FIG. 28. Once an art sheet displayed in the Single Picture Show or Multiple Picture Show is found of interest, the shopper can easily retrieve one identified tube 862 for purchase.

In the above discussion it is assumed that the art sheet 852 attached to the pate 850 for display and the corresponding art sheet roll stored in the case 860 are of the same size. But often the store may carry identical art sheets of several sizes. For example, the art sheets 1, 2, 3, and 4 shown in FIG. 31 can be each available in two different sizes. In order to save the display space all the art sheets of two different sizes can be stored together in the case 860. In each compartment of the case 860, the tubes 862 at the left side can be the art sheets of one size while the tube 862 at the right side can be the same art sheets but of other size. In this situation it is preferable that additional marking on each tube 862 be provided indicating the size of the art sheet.

FIG. 32 shows a display box 800 same as the display box 800 shown in FIG. 31, but is again turned 90 degree as shown. It is attached to a horizontal beam 870. Only a portion of the horizontal beam 870 is shown, and many more display boxes can be held by this horizontal beam 870 along side of the display box 800.

Located below the display box 800 is a case 871 having four compartments 872. Each compartment can hold several art sheet tubes 874 with one designated number. Stored in each tube 874 is an rolled up art sheet.

The electronic circuit of FIG. 29 as well as the computer program in Appendix I can be employed for operating the display box 800 in FIG. 32, for performing the Single Picture Show and Multiple Picture Shows just like in the case of the prototype drawer stand 800 in FIG. 28. Once an art sheet displayed in the Single Picture Show or Multiple Picture Show is found of interest, the shopper can easily retrieve one identified tube 874 for purchase.

The art display box 800 positioned as shown in FIG. 32 has several advantages over the same art sheet display box 800 positioned as shown in FIG. 31. First, in FIG. 31, the view of the displayed art sheet during the Single Picture Show or Multiple Picture Show may get blocked by the art sheet display box 800 especially to shopper standing on the left side in front of the display box 800. The display box positioned as shown in FIG. 32 will occupy less square footage and thus allow more such display boxes to be installed in the store.

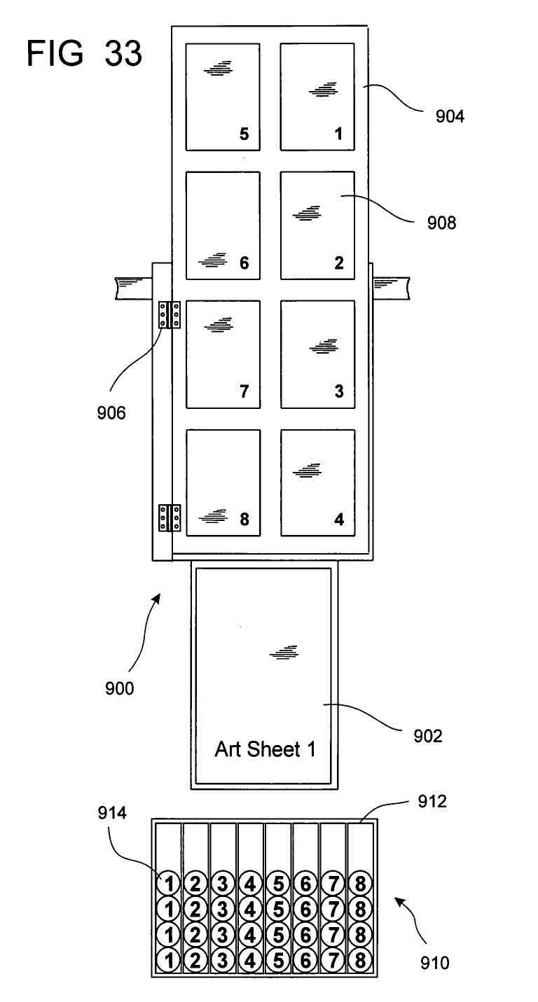

FIGS. 33-35

FIG. 33 shows a display box 900 which is similar to the display box 800 shown in FIG. 32. The main difference is that there are eight art sheets 902 housed inside the display box 900. This means that there will be eight sets of motors, threaded rods, and associated components for supporting and moving these eight art sheets for display.

One more new addition to the display box is a small picture panel 904 rotatably and removably mounted on the display box 900 using two hinges 906. There are eight small picture 908 attached to the panel 904 representing the eight art sheets 902 inside the display box 900. Due to the additional height of the small picture panel 904, the available space needed for more small pictures will be accommodated. Even more than eight small pictures such as 20 to 40 small pictures normally expected in a real display box can also be accommodated if the size of each small picture can be reduced somewhat, but still larger than one hundredth of the art sheet in size. Such display box with tall small picture panel is more suitable in a store with high ceiling.

Located below the display box 900 is a case 910 having eight compartments 912. Each compartment 912 can hold several art sheet tubes 914 with one designated number. Stored in each tube 914 is a rolled up art sheet of that designated number.

The electronic circuit of FIG. 29 as well as the computer program in Appendix I, although still usable, are no longer adequate for the operation of the display box 900 in performing Single Picture Show and multiple Picture Show involving eight art sheets. But the change needed is merely the scale-up of the electronic circuit of FIG. 29 and the computer program. A microcontroller with more I/O ports and a key pad of more pushbuttons will certainly be needed. The computer program as well as the flow chart disclosed in FIG. 30 must also be expanded to address these added I/O ports and key pad buttons.

Upon the completion of the electronic circuit hardware and the computer program software the operation of the display box 900 will be fully enabled. A shopper, after viewing the small pictures 908 on the panel 904, will be allowed to request a Single Picture Show or one of the three Multiple Picture Shows to closely examine any one of the eight art sheets of interest to him. This may lead to the decision to retrieve one or more art sheets from the case 910 for purchase.

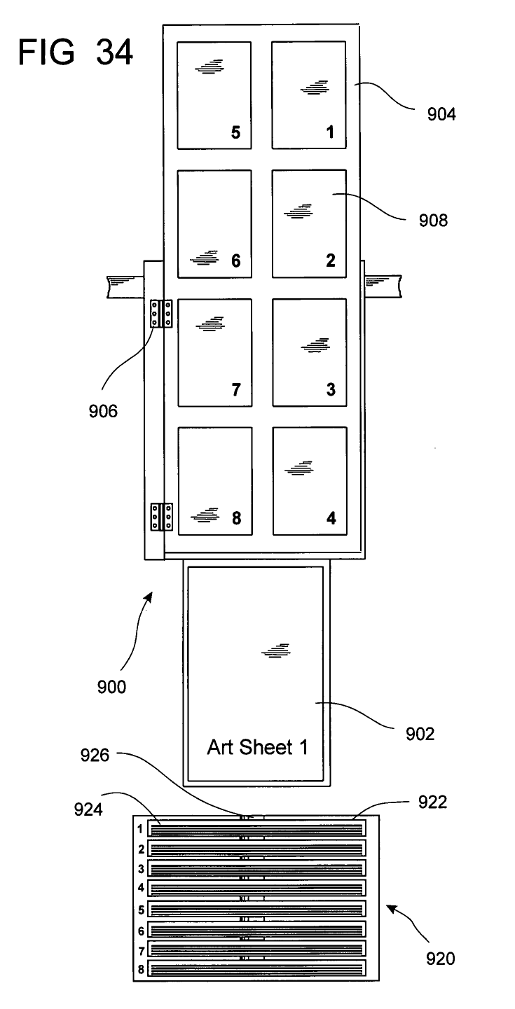

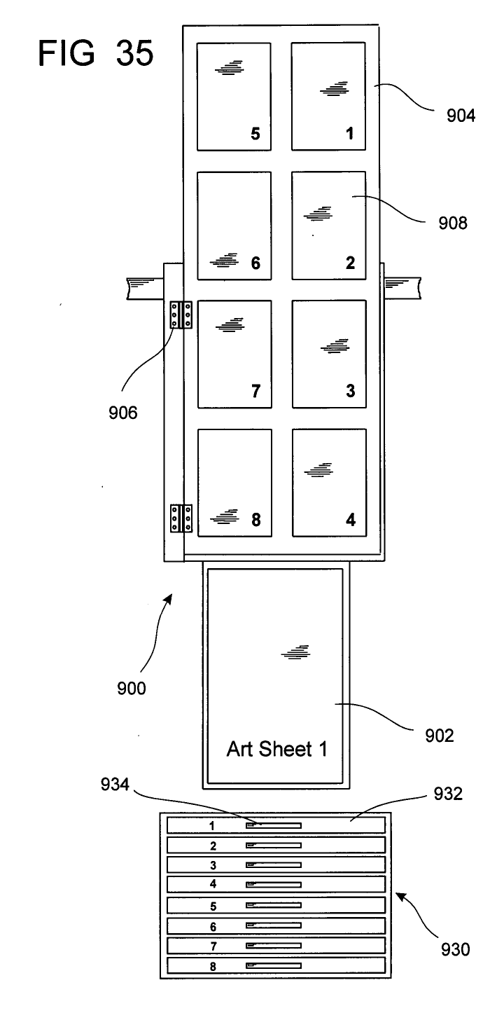

FIG. 34 shows the same display box 900 as the one shown in FIG. 33. Located below the display box 900 is a case 920. This case 920 is shown having eight horizontal compartments 922. Each compartment 922 has a number ranged from 1 to 8 marked on its side. A stack of flat art sheets 924 is placed inside each compartment 920. Each art sheet stored in the compartment 1 is the same as the art sheet 1 displayed by the display box 900 and represented by the small picture 1 on the panel 904. Art sheets in the other compartments 922 are similarly arranged.

Most art prints, as opposed to art posters, are of heavier gauge stocks and not easily rollable. They are more preferably stored as flat sheets. The case 920 is thus mainly designed for storing such art prints.

It is seen in FIG. 34 that on the mid section of the edge of the wall above each horizontal compartment 922 there is a carved recess 926. This recess 926 will provide some space for a finger or a stick with a rubber tip to reach in and grab the top sheet of the art sheet stack 924 and retrieve it out of the compartment 922 for purchase.

FIG. 35 also shows the same display box 900 as the one shown in FIG. 34. Located below the display box 900 is a drawer stand 930. This drawer stand 930 is shown having eight drawers 932. Each drawer 932 has a handle 934 and a marked number ranged from 1 to 8. A stack of art sheets, not shown, but is similar to the art sheet stack 924 shown in FIG. 34, is stored in each drawer 932. Each art sheet stored in the drawer 1 is the same as the art sheet 1 displayed by the display box 900 and represented by the small picture 1 on the panel 904. All sheets in the other drawers 932 are similarly arranged.

After the shopper decides to purchase an art sheet after viewing the small picture 908 and the corresponding art sheet displayed in the display box 900, he can simply grab the handle 934 and open the drawer 932 storing this art sheet. Before taking out one art sheet, he can also carefully examine this art sheet again to confirm his decision.

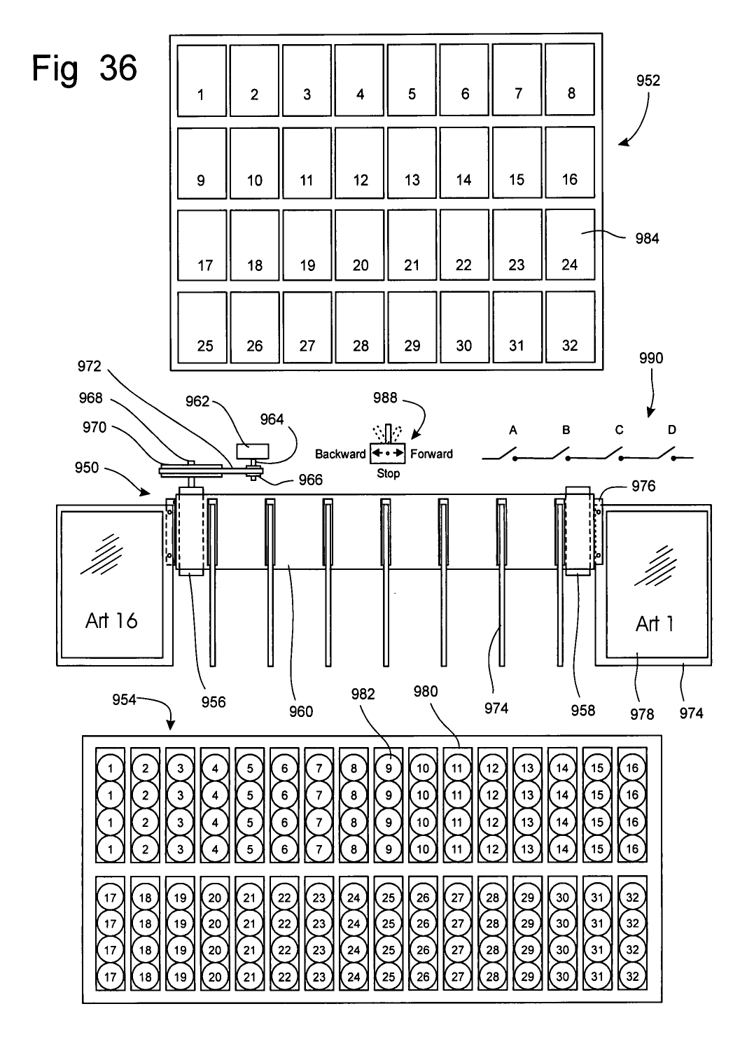

FIG. 36

FIG. 36 shows another preferred embodiment of the art sheets storage, display, and retrieval system of the present invention. This system comprises three parts. The first part is an art sheet display stand 950. The second part includes two small picture panels 952 preferably located above the display stand 950. The third part includes two cases 954 preferably placed beneath the display stand 950.

The display stand 950 has a display stand housing, not shown, on which most display stand components are mounted. It includes two drums 956 and 958, and a belt 960 wrapped around the drums 956 and 958.

A reversible motor 962 is employed for driving the rotative motion of the drum 956. As seen in the figure, the motor 962 has a motor shaft 964 on which a pulley 966 is mounted. The drum 956 also has a shaft 968 on which a pulley 970 is mounted. A belt 972 is wrapped around the pulleys 966 and 970 to transmit the rotative motion of the motor 962 to the drum 956. Since the pulley 970 has a diameter much larger than that of the pulley 966, it effectively reduce the rotation speed of the drum 956 in comparison with that of the motor 962. More such pulleys can be employed if even slower rotation speed of the drum 956 is desired. The rotation of the drum 956 in turn drives the rotation of the belt 960 and the drum 958.

A total of sixteen boards 974 are mounted on and at right angle with respect to the belt 960. This is achieved by fastening each board 974 to an angle iron plate 976 which is in turn fastened to the belt 960. All these boards 974 are equally spaced apart between any two adjacent boards 974 mounted on the belt 960.

A total of thirty two art sheets 978 to be displayed on the display stand 950 are attached to the sixteen boards 974, one on each side of each board 974. All these art sheets 978 are assigned as art 1, art 2, and so on, to art 32. Only art 1 and art 16 are visible as shown in FIG. 36 at this moment.

In a retail store, this display stand 950 can serve as a divider of two adjacent and parallel aisles. A shopper standing on one aisle will see the front side of this display stand 950 just as shown in FIG. 36. A shopper standing on the second aisle will see the back side of this display stand 950 and see the art sheets art 17 and art 32 on display facing the second aisle.

The two cases 954 are placed back to back beneath the display stand 950. As seen in FIG. 36, each case 954 has thirty two vertical compartments 980. Four tubes 982 bearing one art sheet number are shown stored in each compartment 980. In each of these four tubes 982 is a flexible art sheet 978 designated with said art sheet number.

The two small picture panels 952 are placed back to back above the display stand 950. As seen in FIG. 36, each panel 952 has attached thereon thirty two small pictures 984 representing the thirty two art sheets 978 displayed in the display stand 950.

As seen in FIG. 36, a forward/stop/backward switch 988 can be provided for the reversible motor 962. When the switch is turned to the backward position the belt 960 as viewed on the figure will slowly move to the left. The art sheet 16 will gradually rotate backward and then disappear behind the drum 956. At the same time the board 974 carrying the art sheets 14 and 15 will move to the left and gradually bring the art sheet 14 into full view. During this same time period the art sheet 1 will gradually rotate forward and become less visible while the art sheet 31 will move into full view.

It is interesting to note that the space (S) between two adjacent boards 974 on the belt 960 as well as the radius (r) of the drum 956 will affect how clearly the art sheets can be viewed by the shoppers. Obviously, if the space between two adjacent art sheets are too close, the display will be too crowded. It is seen that if the space (S) between two adjacent boards 974 is about equal to 25% of the circumference of the drum 956, i.e., S=πr/2, the board 974 holding the art sheet 15 will be positioned within a plane formed by the vertical axis line of the drum 956 and a horizontal drum diameter line at right angle with respect to the FIG. 36 paper, when the art sheet 16 is at the position as shown in FIG. 36. A shopper standing in front of the board 974 with the art sheet 15 will see the full view of the art sheet 16 without blockage from this board 974. If S is less than πr/2 then when the art sheet 16 is positioned as shown in FIG. 36, the art sheet 15 board 974 will be tilted to the left and partially blocking the view of the art sheet 16. So it is recommended that this space (S) be about equal to or slightly larger than πr/2 in order to assure an unblocked full view of each art sheet for shopper viewing.

A shopper walking down the store aisle can pause at the front of the display stand 950 and view the small pictures 984 on the panel 952 to see if there is any picture of interest to her. If there is no one picture of interest to her, she can leave and walk down to the next display stand to continue her art search. If say, the small picture 22 is of interest to her, she can push the switch 988 to the forward position and then move to the front of the art sheet 16. As the belt 960 moves forward the art sheet 22 will quickly move to the position right in front of her. She can next push the switch 988 to the stop position and leisurely examine the art sheet 22 in front of her. If her interest is further confirmed she can go ahead retrieve one tube 22 from the case 954 for purchase.

With the present design of the display stand 950, it is possible for four persons each standing in front of one of the four art sheets 1, 16, 17, and 32 viewing the moving art sheet display. It is unfair for just one person having the full control of the switch 988. One compromised solution is to have four on/off switches 990, one at each of the four comers of the display stand 950. These four switches 990 are connected in series as shown in FIG. 36. Normally all four switches A, B, C, and D are in the on position which allows the belt 960 to rotate forward continuously. This will allow the four shoppers standing at the four comers to view all art sheets, one by one, move in to the front of each shopper for full view. Any shopper can turn one of the four on/off switches to the off position which will stop the belt movement. After close examination of the stopped art sheet in front of this shopper, she must quickly turn the switch back to the on position allowing all other three shoppers to continue viewing the moving art display while she can proceed to pick up the art sheet roll from the case 954 for purchase.

It is possible to redesign the four on/off switches 990 so that once a shopper pushes one switch to the off position a timer will be automatically activated to turn the switch back to the on position after ten seconds. Further design change is also possible so the belt will move at least a distance of S before the switch can be pushed to the off position again.

In FIG. 36, the case 954 can be replaced by a case similar to the case 920 or a drawer stand when flat art sheets are to be stored and retrieved.

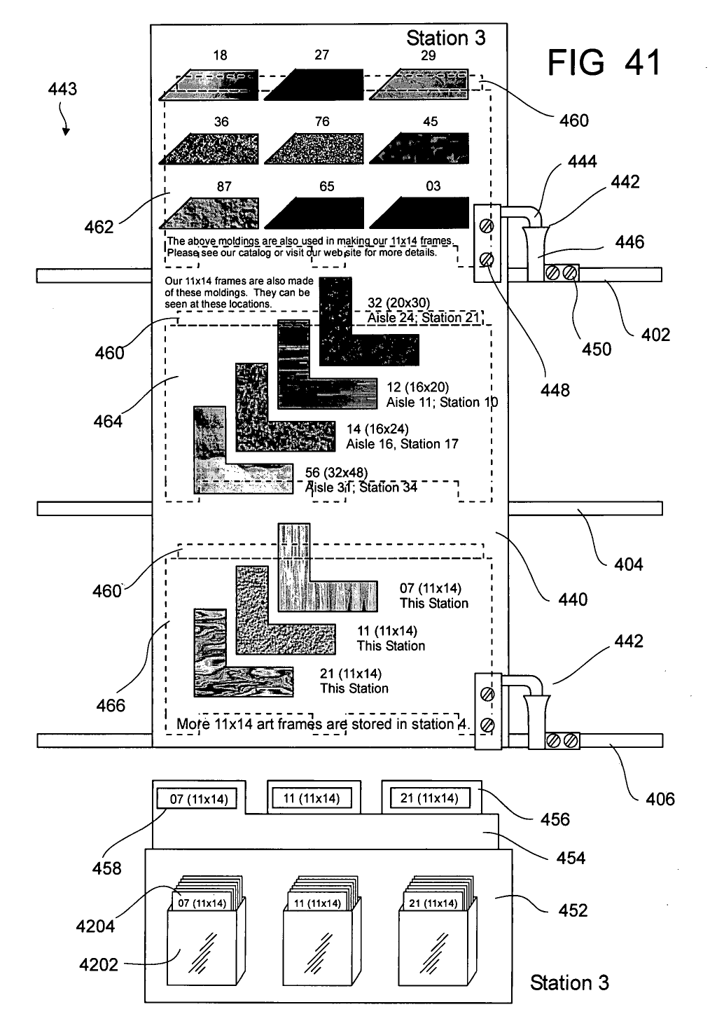

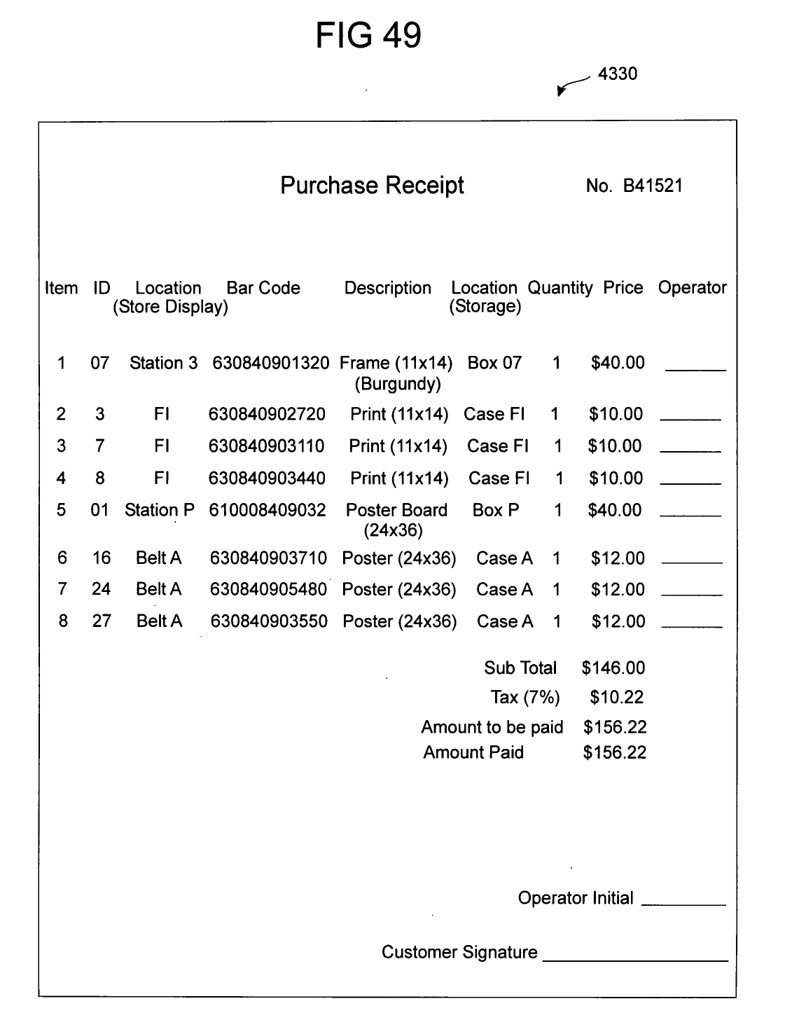

FIGS. 41-52

So far it is assumed that once a customer has decided what art frame and art sheets to purchase, he will need to physically pick up these products and take them to the checkout counter for the purchase. This is a physical labor demanding work, not easily performed by some shoppers. A cart will be needed to carry them to the checkout counter. The presence of all these bulky carts will naturally reduce the number of shoppers allowable in the store at any given time.

To properly stock each large art sheet in the store for customer pickup and checkout, some protection to the art sheet may need to be provided. A large flat art sheet may need a heavy gauge cardboard backing and transparent sheet wrapping. An art poster will usually need to be curled and stored in a cardboard tube. Such protection will naturally add to the cost of each art sheet and require some customer effort to put it in the frame eventually.

In order to properly check out each art frame and art sheet for purchase, a bar code label will need to be attached to each product. In the case of art sheets, these bar code label can be either printed on or glued to the art sheet. Neither approach is desirable due to labor requirement or aesthetic concern. The physical scanning of each product is also a laborious task for the store clerk due to the large size of each product.

During shopping, the customer may decide not to purchase one art sheet or one art frame picked up earlier, in favor of one other product picked up later. The restocking of art sheet or art frame not purchased will require considerable restocking effort to be done either by the customer or the store personnel.

FIGS. 41-52 disclose some innovative improvements in the method of buying and selling art sheets and art frames in a retail store. With these improvements, all above concern on additional cost in art sheet protection, customer handling of art sheet and art frame, need of carts, and application of bar code on art sheets will be alleviated.

FIG. 41 is a copy of FIG. 17 which was described above. The only items added are three pockets 4202 and three stacks of art frame slips 4204 placed in the pockets 4202. The pockets 4202 are each an open top box attached to the display box 452.

In the display box 452, only one each of the three art frames 07(11×14), 11(11×14), and 21(11×14) needs to be kept as a sample for the purpose of display. The shoppers needing to purchase these art frames will be instructed to pick up the corresponding art frame slips 4204 and take them to the checkout counter for purchase.

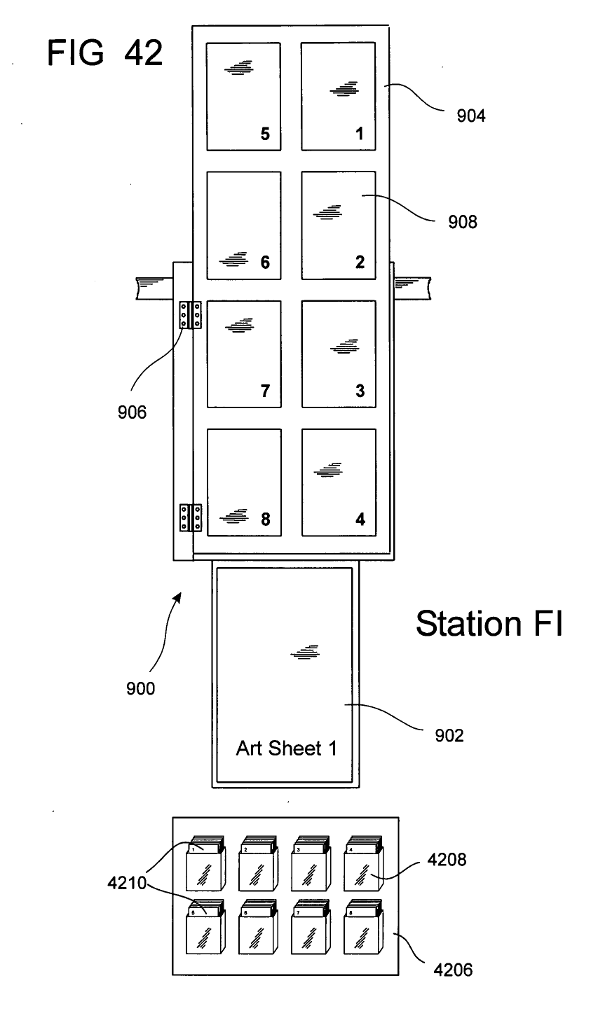

FIG. 42 is a copy of FIG. 34 which was described above. The only change is the replacement of the art sheet case 920 by a vertically positioned panel 4206. Eight open top boxes or pockets 4208 are attached to this panel 4206. Eight stacks of art sheet slips 4210 are placed in these eight pockets 4208. Each stack of art sheet slips 4210 provide information on one small picture 908 as well as one art sheet 902 to be displayed by the display box 900.

After viewing the small pictures 908 on the small picture panel 904 and the actual art sheets 902 displayed by the display box 900, the customer may decide to purchase one or more art sheets displayed in this station FI. Instead of picking up the actual art sheets for purchase, the customer can simply retrieve these corresponding art sheet slips 4210 for checkout.

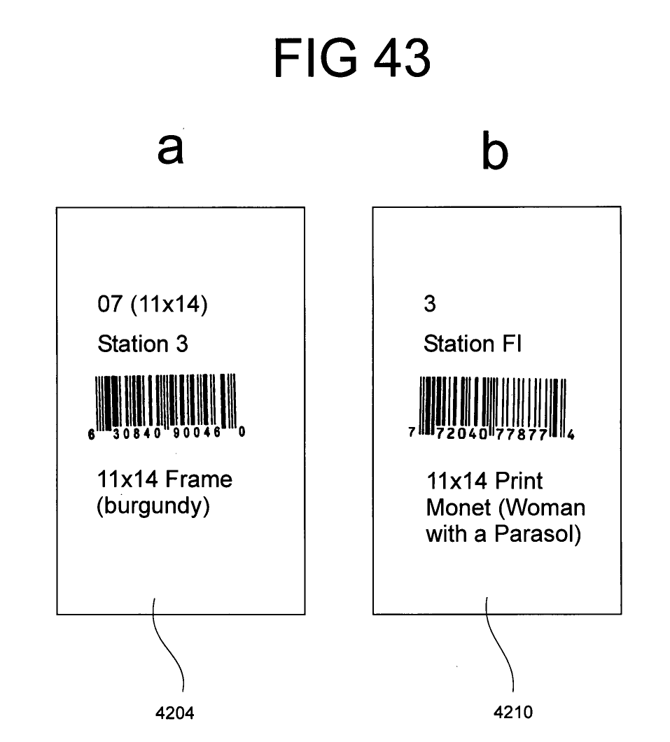

FIG. 43 shows the details of one art frame slip 4204 and one art sheet slip 4210. The first line of each slip is the ID of the product. The second line lists the location of this product, in case the shopper needs to return to take a second look of this product to confirm his purchasing decision. The third line is the bar code of this product for scanning at the checkout counter. The fourth line is a description of the product.

The bar code of the art frame slip 4204 and the art sheet slip 4210 scanned at the checkout counter will provide the information to the personnel in the store's service department what products have been purchased and where these products in the storage area can be retrieved.

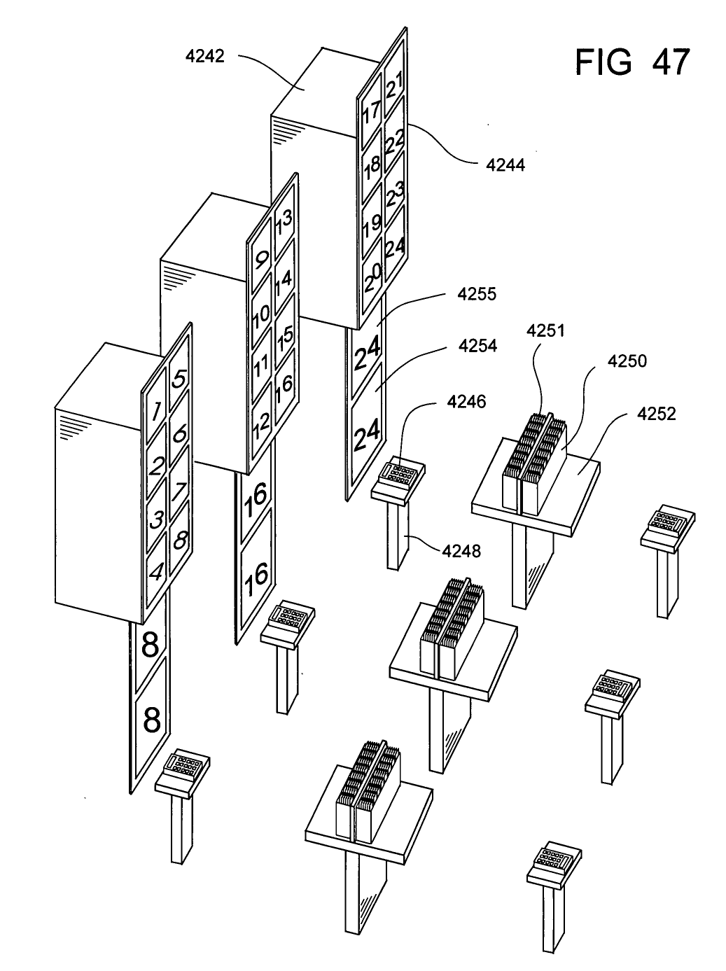

FIG. 47 shows some further improvements on the present small picture panel-art display box-art sheet slips operation. Shown in this figure are three stations along a store's aisle. Each station comprises an art display box 4242, a small picture panel 4244, a keypad 4246 which is placed on a keypad stand 4248, and an art sheet slip box 4250 which is mounted on an art sheet slip box stand 4252.

A person standing right in front of a keypad 4246 will have the control of the operation of the art display box 4242. Because of closeness to the displayed art sheet 4254, this person can also feel and touch this art sheet. If further interested, he can walk to the art sheet slip box 4250 behind him to pick up one corresponding art sheet slip 4251 for purchase later.

It is possible during the peak hour many shoppers may be present in the store to watch the art sheet display in front of each station. It is preferable that the space between the keypad stand 4248 and the art sheet slip box stand 4252 be wider than 2 ft. (61 cm) to accommodate up to three layers of people within this space.

One improvement on the design of the art display box 4242 is that during the single picture show or multiple picture show, two identical art sheets 4254 and 4255 are displayed simultaneously. This will allow at least one art sheet to be easily seen by shoppers standing further back away from the front row.

It is seen in FIG. 47 that it is preferable that the art sheet slip box 4250, as well as the art sheet slips 4251, be placed at least 3 ft. (91 cm) away from the displayed art sheets 4254 and 4255. In this way, the shoppers retrieving the interested art sheet slips 4251 will not interfere with shoppers at front viewing the displayed art sheets.

As stated previously, the use of the product slips may eliminate the need of carts in a store. But such carts can still be used by the operator in the store's service department and by the customer walking to the parked car. Furthermore, shoppers may still like to use small hand-held baskets inside the store for holding small items to be purchased. Such baskets can be ideally parked in the space underneath the art sheet slip box stand 4252 while the shopper is searching the arts displayed in this same station.

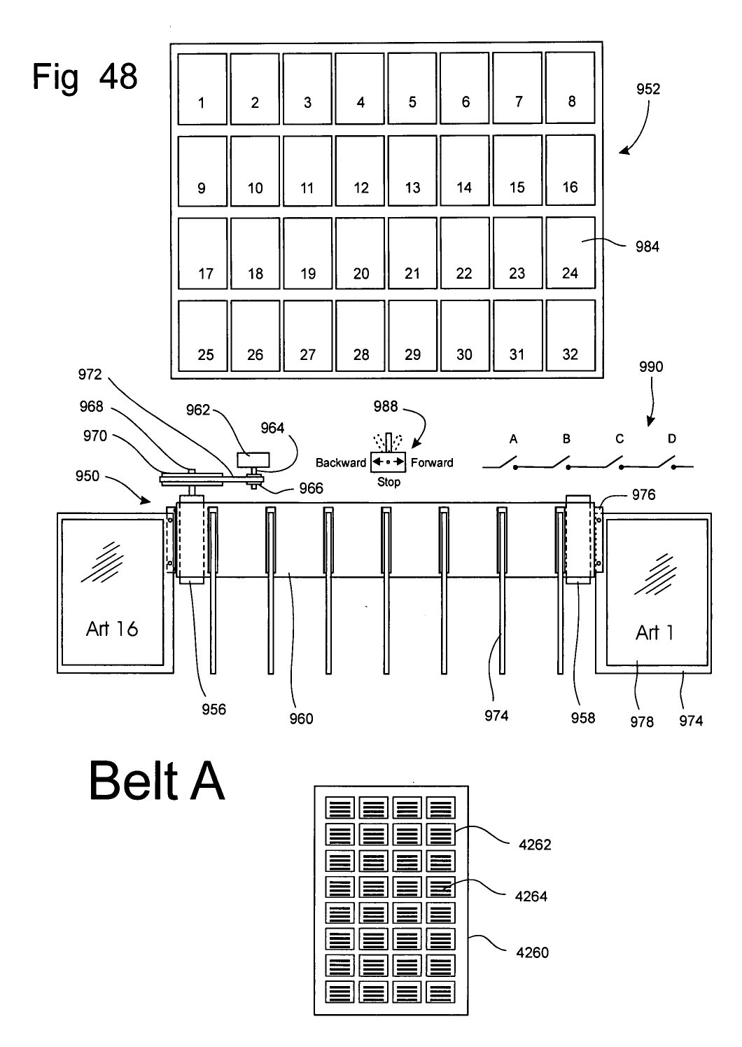

FIG. 48 is a copy of FIG. 36 except for the replacement of the two art sheet cases 954 in FIG. 36 by two art sheet slip cases 4260. Each case 4260 has 32 storage compartments 4262 with each one storing a plurality of art sheet slips 4264 describing one corresponding art sheet on display in the art sheet display stand 950. The use of the art sheet slip case 4260 will allow the shopper to retrieve the art sheet slips 4264 from the case 4260, instead of retrieving the actual art sheets for purchase. This rotating belt station is assigned with a name “Belt A”.

After picking up all product slips for the art sheets, art frames, and others to be purchased, the shopper walks to the checkout counter and has all the slips scanned by the store clerk. After making the payment, the shopper receives a purchase receipt such as the purchase receipt 4330 shown in FIG. 4330 shown in Fig, 49. He will then wait a few minutes until the receipt's number is called or flashing, indicating that the purchased items are ready for pickup at the customer service department.

The first purchase shown on the purchase receipt 4330 is a 11×14 burgundy picture frame. The frame slip 4204, as shown in FIG. 43, indicates that this frame has an ID of 07, and its corner sample is displayed in the shelf station 3, as 443, shown in FIG. 41. The scanning of the bar code of the frame slip 4204 producing a printout line indicating the price of $40 and that that it is available and stored in a box marked as Box 07 in the store's storage area. All other purchased items are also similarly printed on the purchase report.

When this purchase receipt 4330 is printed out at the checkout counter and given to the customer, one identical purchase receipts 4330 is also immediately printed in a printer in the store's service department connected to the computer at the checkout counter. For a less fully equipped store, all these two identical purchase receipts 4330 can also be printed at the checkout counter. The customer is then asked to bring them to the customer service department to be filled.

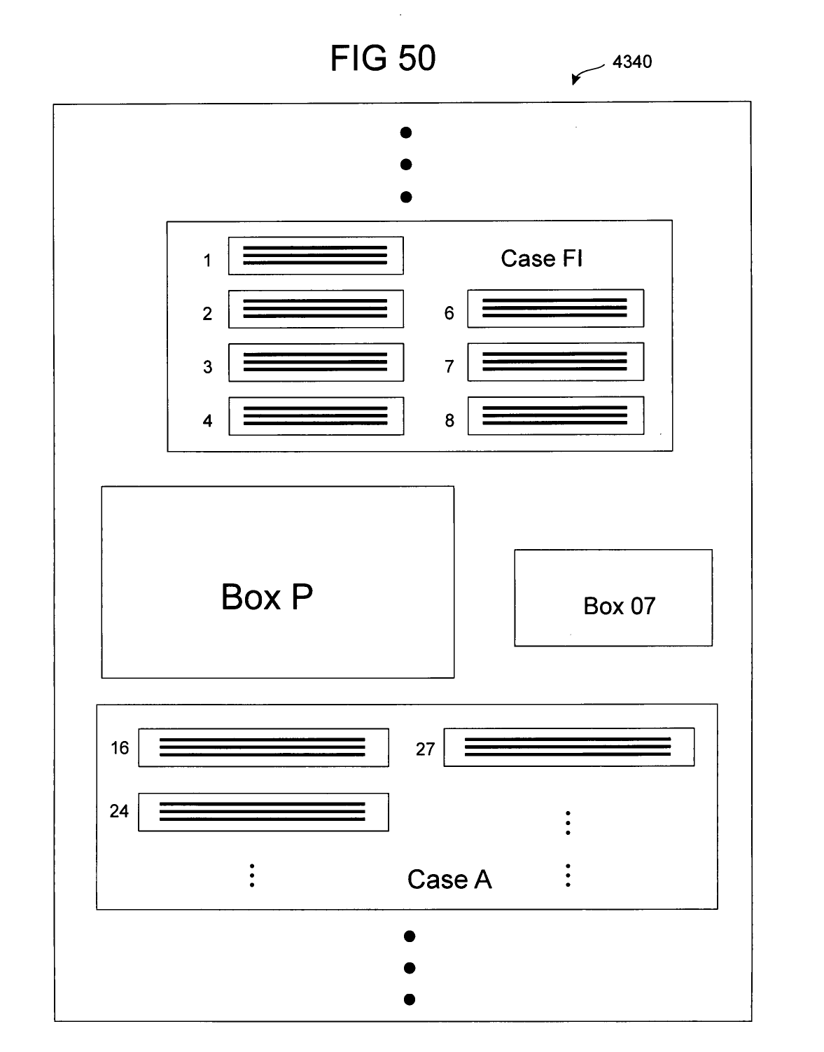

Once an operator in the store's customer service department sees a new purchase receipt in the printer, he needs to work on this task. All the items to be picked up can be retrieved from within the store's product storage area. FIG. 50 shows a hypothetic storage area 4340, showing four storage locations. These four storage locations are Box 07, Case Fl, Box P, and Case A, storing the 11×14 frame, three 11×14 art sheets, the poster board, and three poster arts, respectively, indicated on the purchase receipt 4330.

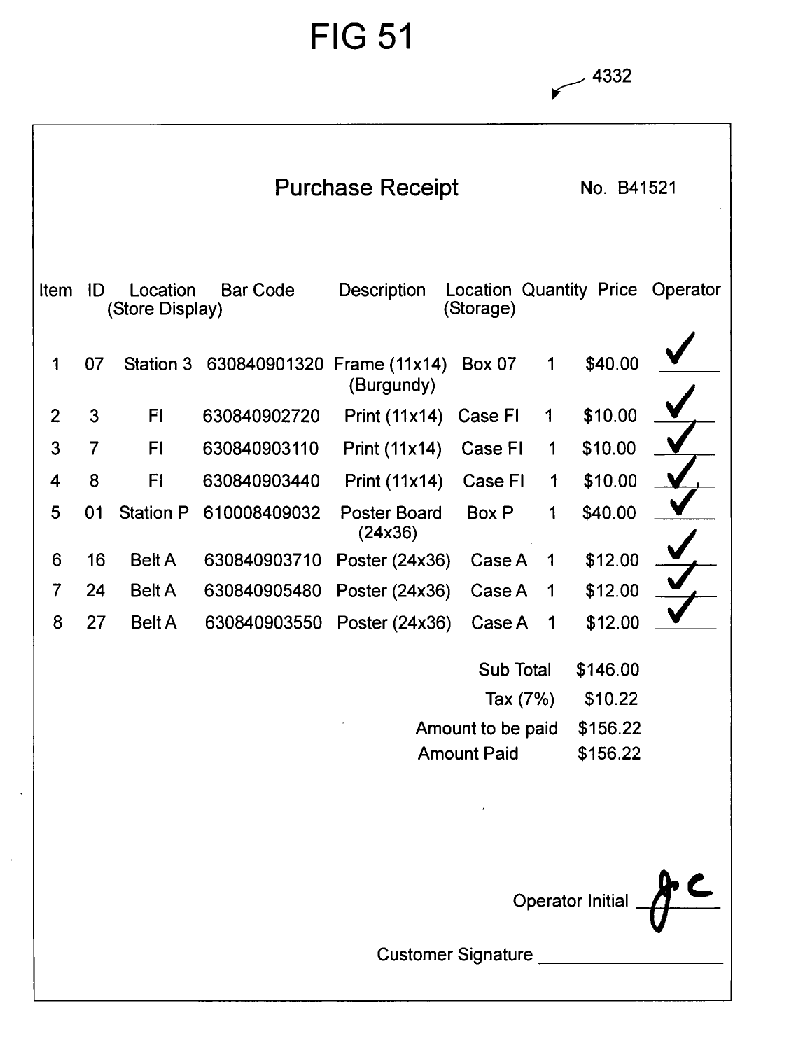

After retrieval of each purchased item a check mark can be written on the purchase receipt 4230. After successful retrieval of all purchased items on the purchase receipt 4330, the operator should write his initial on this receipt. FIG. 51 illustrates such a purchase receipt 4332 with operator's check marks and initial.

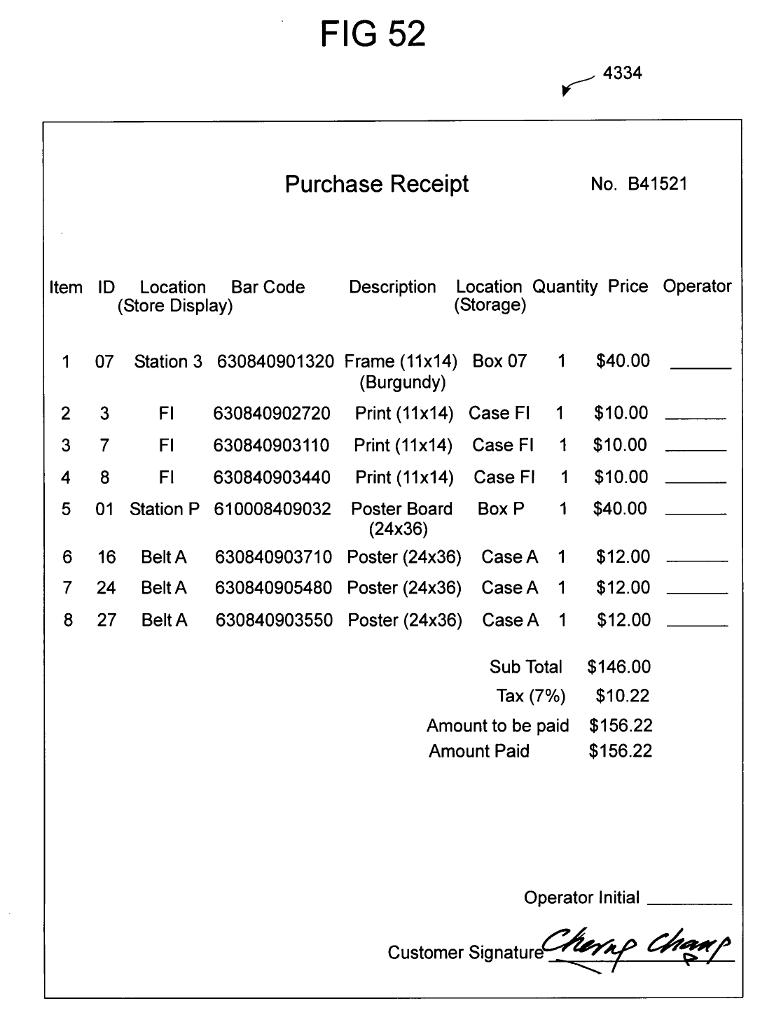

At the pickup counter, the receipt 4332 with operator's check marks and initial will be given to the customer. At the same time the customer will be asked to turn in the other receipt 4330, which become 4334 now, shown in FIG. 52, with his signature. The customer will pick up the purchased items which complete the business transaction.

The present novel art sheet display-art sheet slip-customer pickup system also provides one benefit to the customer. The delivered 11×14 frame will be pre-assembled with the three purchased 11×14 art sheets, while the 24×36 poster board will be pre-assembled with the three purchased 24×36 art posters. Customers will appreciate such additional service because the products will be ready for hanging once they are brought home by the customer.

The present novel practice will also make customer's shopping more enjoyable, without the need to pick up each individual bulky items for checkout. The store will save on the cost of art sheet bar coding and packaging and minimize the chore of restocking the picked-up but un-purchased art sheets. More importantly, the present novel art searching practice will bring in more happy customers and increase the art business.

The invention having thus been described, the following is claimed:

1. A system in a retail store, comprising:
(A) a display unit, comprising:
(a) a plurality of motors for moving as many art sheets each reciprocally between a concealed position and an exposed position,
(b) a computer for operating said motors, and
(c) a requesting member for a store shopper to request a display operation of said display unit.

2. The system of claim 1 in which said computer includes a microcontroller.

3. The system of claim 2 in which said microcontroller includes an imbedded computer program for operating said microcontroller for operating said motors.

4 The system of claim 1 in which said requesting member includes a keypad.

5. The system of claim 1 also comprising:
(B) a panel showing small pictures each representing one of said art sheets.

6. The system of claim 1 also comprising:
(B) stacks of slips, each slip having a bar code representing one of said art sheets, scanable at said store's checkout counter for purchase of an art sheet represented by said bar code.

7. The system of claim 6 also comprising:
(C) a storage device storing said an art sheet, which is retrievable for said purchase.

8. A system in a retail store, comprising:
(A) a display unit, comprising:
(a) a moving loop belt carrying a plurality of art sheets for display, and
(b) a motor for driving the motion of said loop belt.

9. The system of claim 8 also comprising:
(B) a panel showing small pictures each representing one of said art sheets.

10. The system of claim 8 also comprising:
(B) stacks of slips, each slip having a bar code representing one of said art sheets, scanable at said store's checkout counter for purchase of an art sheet represented by said bar code.

11. The system of claim 10 also comprising:
(C) a storage device storing said an art sheet, which is retrievable for said purchase.

12. The system of claim 8 in which said display unit also has:
(c) means for mounting said art sheets each at right angle with respect to the outer surface of said loop belt.

13. The system of claim 8 in which said display unit also has:
(c) a drum in engagement with said motor for driving the motion of said loop belt.

14. A method of displaying art sheets in a retail store, comprising the steps of:
(A) providing a plurality of motors for moving each of said art sheets from a concealed position to an exposed position for display, and
(B) providing a requesting member for a shopper in said retail store to request a display of one or more of said art sheets.

15. The method of displaying art sheets of claim 14 also comprising the step of:
(C) requesting a single picture show in which one requested art sheet in said art sheets is moved to its exposed position for display.

16. The method of displaying art sheets of claim 14 also comprising the step of:
(C) requesting an all pictures show in which all of said art sheets are displayed, one art sheet at a time, for a pre-determined duration.

17. The method of displaying art sheets of claim 16 also comprising the step of:
(D) requesting to halt said all pictures show whereby more time will be allowed for examining the presently displayed art sheet.

18. The method of displaying art sheets of claim 17 also comprising the step of:
(E) requesting to resume said all pictures show after it has been halted.

19. The method of displaying art sheets of claim 14 also comprising the step of:
(C) requesting a pre-selected pictures show in which a pre-selected group in said art sheets are displayed, one art sheet at a time, for a predetermined duration.

20. The method of displaying art sheets of claim 14 also comprising the step of:
(C) requesting, by a store shopper, a select pictures show in which a group in said art sheets, selected by said store shopper, are displayed, one art sheet at a time, for a predetermined duration.
